(19) United States
(12) Patent Application Publication
(10) Pub. No.: US 2026/0119469 A1
(43) Pub. Date: Apr. 30, 2026

(54) GENERATING UNIFIED LOGBOOK DATA

(71) Applicant: HighChem s. r. o., Ružinov District (SK)

(72) Inventor: Karol Nagyeri, Horne Saliby (SK)

(21) Appl. No.: 19/361,811

(22) Filed: Oct. 17, 2025

Related U.S. Application Data
(60) Provisional application No. 63/712,916, filed on Oct. 28, 2024.

(51) Int. Cl. G06F 16/215; G06F 9/54; G06F 16/25; G06F 21/62; G06N 20/00

(52) U.S. Cl. CPC G06F 16/215; G06F 9/542; G06F 16/254; G06F 21/6218; G06N 20/00

(57) ABSTRACT

A system for generating unified logbook data. The system includes at least one electronic processor. The at least one electronic processor is configured to receive, from a user device, a request to register the user device with a logbook processing service based on a registration credential, in response to registering the user device, receive a user login credential from the user device, and, in response to verifying the user login credential, receive an image of logbook data from the user device. The at least one electronic processor is also configured to, in response to receiving the image of logbook data, record a unique identifier of the user device along with an indication of the logbook data included in the image of logbook data, extract textual logbook data from the image, and organize the extracted textual logbook data into a structured format, using a model, to generate unified logbook data.

### FIELD

Implementations described herein relate to the management of logbook data.

### SUMMARY

Many users (for example, researchers, scientists, and lab technicians) keep paper laboratory journals or lab logbooks with manual (handwritten) entries. For example, paper lab logbooks may include a plurality of pages of logbook data. Each page of logbook data may include one or more logbook entries. Such paper-based lab logbooks are susceptible to mistakes, outdated standards, and damage. Also, even if users keep digital lab logbooks, digital logbooks, like paper lab logbooks, are susceptible to mistakes and outdated standards.

Implementations described herein digitize and organize such existing logbook data (e.g., according to current standards). A model may be used to automatically categorize and organize logbook entries included in logbook data based on their content to generate unified logbook data. The categorization and organization of logbook data may allow relevant information to be quickly and efficiently located. Improving the searchability of the logbook data allows relevant information to be retrieved with fewer and faster searches, requiring less processing power of the computer performing the searching. The categorization and organization of logbook data may also streamline data analysis processes. In some implementations, a model may be used to generate suggestions regarding organizing logbook data.

Implementations described herein may also detect anomalies in digitized logbook entries, which may represent spelling errors, grammar errors, deviations from established patterns (e.g., learned via machine learning), and the like. Implementations may also generate notifications regarding such anomalies or other status updates for logbook entries (e.g., when logbook entries are uploaded, accessed, etc.).

For example, sample error notifications may be generated with a model leveraging historical data from lab logbooks identifying patterns and correlations between specific sample characteristics and subsequent issues. Sample error notifications may identify potential issues with samples and allow users to take proactive measures to address the potential issues.

Logbook data can be communicated securely to a remote computing device for digitization, unification, and optional analysis and the results can similarly be stored securely. Therefore, implementations described herein provide systems and methods for ensuring only authorized users and devices can access, modify, and add to digitized and/or unified logbook data. The systems and methods described herein may also capture actions performed by authorized users on digitized and/or unified logbook data in the form of searchable audit trails. Specifically, implementations described herein receive, from a user device, a request to register the user device with a logbook processing service based on a registration credential and, in response to registering the user device, receive a user login credential from the user device. In response to a user device being registered and a user login credential being verified, an image of logbook data may be received from the user device. When the image is received, a unique identifier of the user device along with an indication of the logbook data included in the image of logbook data may be recorded so that an audit trail may be generated upon request. Audit trails may provide proof that digital logbook data has been securely maintained and help to identify where any issues or errors associated with digital logbook data originated from.

For example, in some implementations, a system for generating unified logbook data is provided. The system includes at least one electronic processor, the at least one electronic processor is configured to, receive, from a user device, a request to register the user device with a logbook processing service based on a registration credential. The electronic processor is also configured to, in response to registering the user device, receive a user login credential from the user device, and, in response to verifying the user login credential, receive an image of logbook data from the user device, wherein logbook data includes data collected using one or more scientific instruments. The electronic processor is also configured to, in response to receiving the image of logbook data, record a unique identifier of the user device along with an indication of the logbook data included in the image of logbook data, extract textual logbook data from the image using natural language processing, and organize the extracted textual logbook data into a structured format, using a model, to generate unified logbook data.

In other implementations a method for generating unified logbook data is provided. The method includes receiving, from a user device, a request to register the user device with a logbook processing service based on a registration credential. The method also includes, in response to registering the user device, receiving a user login credential from the user device and, in response to verifying the user login credential, receiving an image of logbook data from the user device, wherein logbook data includes data collected using one or more scientific instruments, in response to receiving the image of logbook data. The method further includes recording a unique identifier of the user device along with an indication of the logbook data included in the image of logbook data, extracting textual logbook data from the image using natural language processing, and organizing the extracted textual logbook data into a structured format, using a model, to generate unified logbook data.

Thus, implementations described herein provide systems and methods for maintaining logbook data security by registering user devices and verifying login credentials. Implementations described herein also provide assurance or proof of the security of logbook data by recording the unique identifier of the user device an image of logbook data is received from along with an indication of the logbook data included in the image of logbook data.

### BRIEF DESCRIPTION OF THE DRAWINGS

Implementations will be readily understood by the following detailed description in conjunction with the accompanying drawings. To facilitate this description, like reference numerals designate like structural elements. Implementations are illustrated by way of example, not by way of limitation, in the figures of the accompanying drawings.

FIG. 1 is a block diagram of a system for generating unified logbook data, in accordance with various implementations.

FIG. 2 is a block diagram of an electronic computing device included in the system of FIG. 1, in accordance with various implementations.

FIG. 3 is a block diagram of a first user device included in the system of FIG. 1, in accordance with various implementations.

FIG. 4 is a flowchart of an example method for generating unified logbook data, in accordance with various implementations.

FIG. 5 is a flowchart of a method for registering a user device and capturing logbook data, in accordance with various implementations.

FIG. 6 provides an example of graphical user interfaces (GUIs) generated by the first user device of FIG. 3, in accordance with various implementations.

FIGS. 7-10 are an illustrative example of unified logbook data and notifications that may be generated regarding logbook data, in accordance with some implementations.

FIG. 11 is a graphical illustration of sample errors determined for a logbook entry included in received logbook data, in accordance with various implementations.

FIG. 12 is a graphical illustration of anomalies determined for a logbook entry included in the received logbook data, in accordance with various implementations.

FIG. 13 is a graphical illustration of organization actions determined for a logbook entry included in the received logbook data, in accordance with various implementations.

FIG. 14 is an example GUI including a table of logbook entries, in accordance with various implementations.

FIG. 15 is an example GUI displaying details regarding a logbook entry, in accordance with various implementations.

FIG. 16 is a swim lane diagram illustrating communications sent between physical and software components of the system of FIG. 1 when the functionality described herein is performed, in accordance with various implementations.

FIG. 17 provides an example list of the data included in a training data example used to train a machine learning model utilized to perform the method of FIG. 4, in accordance with various implementations.

### DETAILED DESCRIPTION

In the following detailed description, reference is made to the accompanying drawings that form a part hereof wherein like numerals designate like parts throughout, and in which is shown, by way of illustration, implementations that may be practiced. It is to be understood that other implementations may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described implementation. Various additional operations may be performed, and/or described operations may be omitted in additional implementations.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an implementation,” “various implementations,” and “some implementations,” each of which may refer to one or more of the same or different implementations. Furthermore, the terms “comprising,” “including,” “having,” and the like, as used with respect to implementations of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if implementations described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

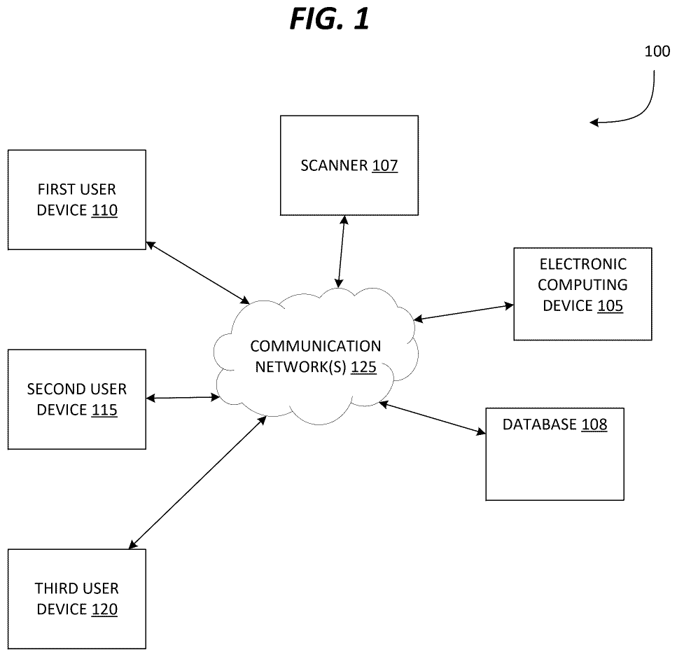

FIG. 1 is a block diagram of a system 100 for generating unified logbook data, in accordance with various implementations. In some implementations, the system 100 includes an electronic computing device 105, a scanner 107, a database 108, and one or more user devices (for example, the first user device 110, the second user device 115, and the third user device 120).

Each of the one or more user devices may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.) or a desktop computing device. In some implementations, the electronic computing device 105 is a server computing device or other networked computing component.

In some implementations, the electronic computing device 105, scanner 107, the database 108, and one or more user devices are connected via one or more communication networks 125. The communication networks may be wired or implemented wirelessly using any suitable protocol. For example, the communication networks 125 may be implemented using a wide area network (for example, the Internet), a local area network (for example, a Wi-Fi network), and combinations or derivatives thereof. The number of components illustrated as being included in the system 100 is purely illustrative and the system 100 may include fewer or additional components than those illustrated in FIG. 1. For example, the system may include more user devices than the three user devices illustrated as being included in the system 100 of FIG. 1.

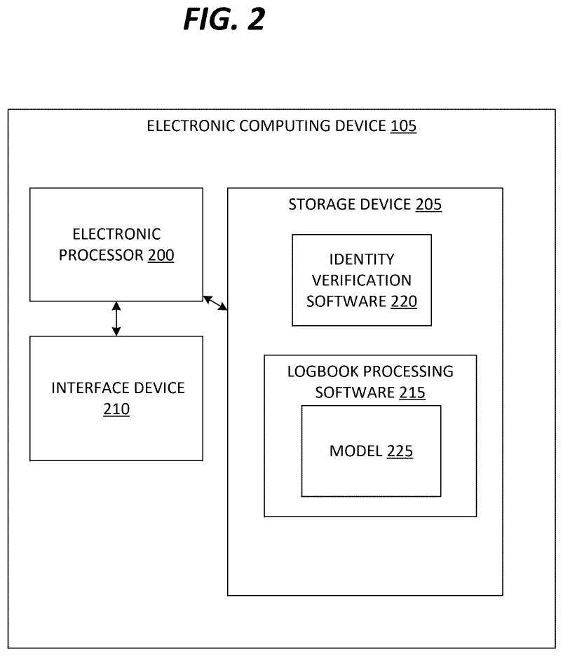

FIG. 2 is a block diagram of the electronic computing device 105. In some implementations, the functionality described as being performed by the electronic computing device 105 may be performed by multiple electronic computing devices. The electronic computing device 105 of FIG. 2 is illustrated as having a number of components, but any one or more of these components may be omitted or duplicated, as suitable for the application and setting. In some implementations, some or all of the components included in the electronic computing device 105 may be attached to one or more motherboards and enclosed in a housing (e.g., including plastic, metal, and/or other materials). In some implementations, some these components may be fabricated onto a single system-on-a-chip (SoC) (e.g., an SoC may include one or more electronic processors 200 and one or more storage devices 205).

The electronic computing device 105 may include an electronic processor 200 (e.g., one or more electronic processors 200). As used herein, the term “electronic processor” may refer to any device or portion of a device that processes electronic data from registers and/or memory to transform that electronic data into other electronic data that may be stored in registers and/or memory. The electronic processor 200 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The electronic computing device 105 may include a storage device 205 (e.g., one or more storage devices). The storage device 205 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some implementations, the storage device 205 may include memory that shares a die with the electronic processor 200. In such an implementation, the memory may be used as cache memory and may include embedded dynamic random access memory (eDRAM) or spin transfer torque magnetic random access memory (STT-MRAM), for example. In some implementations, the storage device 205 may include non-transitory computer readable media having instructions thereon that, when executed by one or more processing devices (e.g., the electronic processor 200), cause the electronic computing device 105 to perform any appropriate ones of or portions of the methods disclosed herein. In some implementations, the storage device 205 includes logbook processing software 215 and identity verification software 220. In some implementations, the logbook processing software 215 includes or utilizes a model 225. In some implementations, the model 225 is a machine learning model. In other implementations, the model 225 is a rules-based model. It should be understood that the single model 225 included in FIG. 2 is purely illustrative and that the storage device 205 may include a different number of models. The models included in the storage device 205 may be machine learning models, rules-based models, or a combination of machine learning models and rules-based models. The functionality performed when the logbook processing software 215, the identity verification software 220, and the model 225 are executed by the electronic processor 200 is described in further detail below. It should be understood that functionality described below as being performed by the logbook processing software 215, the identity verification software 220, or the model 225 is performed by the electronic processor 200 when the electronic processor 200 executes the logbook processing software 215, the identity verification software 220, or the model 225.

The electronic computing device 105 may include an interface device 210 (e.g., one or more interface devices 210). The interface device 210 may include one or more communication chips, connectors, and/or other hardware and software to govern communications between the electronic computing device 105 and other computing devices (for example, the first user device 110, the second user device 115, and the third user device 120) via the communications network 125. For example, the interface device 210 may include circuitry for managing wireless communications for the transfer of data to and from the electronic computing device 105. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some implementations they might not. Circuitry included in the interface device 210 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some implementations, circuitry included in the interface device 210 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some implementations, circuitry included in the interface device 210 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some implementations, circuitry included in the interface device 210 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some implementations, the interface device 210 may include one or more antennas (e.g., one or more antenna arrays) to receipt and/or transmission of wireless communications.

In some implementations, the interface device 210 may include circuitry for managing wired communications, such as electrical, optical, or any other suitable communication protocols. For example, the interface device 210 may include circuitry to support communications in accordance with Ethernet technologies. In some implementations, the interface device 210 may support both wireless and wired communication, and/or may support multiple wired communication protocols and/or multiple wireless communication protocols. For example, a first set of circuitry of the interface device 210 may be dedicated to shorter-range wireless communications such as Wi-Fi or Bluetooth, and a second set of circuitry of the interface device 210 may be dedicated to longer-range wireless communications such as global positioning system (GPS), EDGE, GPRS, CDMA, WiMAX, LTE, EV-DO, or others. In some implementations, a first set of circuitry of the interface device 210 may be dedicated to wireless communications, and a second set of circuitry of the interface device 210 may be dedicated to wired communications.

The electronic computing device 105 may include battery/power circuitry. The battery/power circuitry may include one or more energy storage devices (e.g., batteries or capacitors) and/or circuitry for coupling components of the electronic computing device 105 to an energy source separate from the electronic computing device 105 (e.g., AC line power).

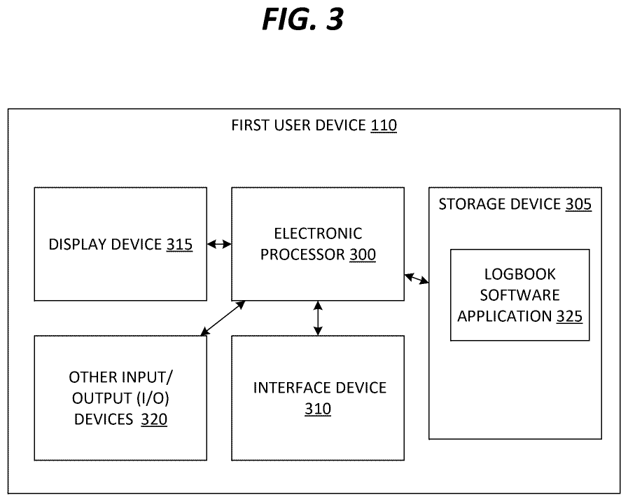

FIG. 3 is a block diagram of the first user device 110. The first user device 110, like the electronic computing device 105, may include an electronic processor 300, a storage device 305, and an interface device 310. The electronic processor 300, storage device 305, and interface device 310 included in the first user device 110 may be similar to the electronic processor 200, storage device 205, and interface device 210 included in the electronic computing device 105 as described above. In some implementations, the storage device 305 includes a logbook software application 325.

Additionally, the first user device 110 may include a display device 315 (e.g., multiple display devices). The display device 315 may include any visual indicators, such as a heads-up display, a computer monitor, a projector, a touchscreen display, a liquid crystal display (LCD), a light-emitting diode display, or a flat panel display.

The first user device 110 may include other input/output (I/O) devices 320. The other I/O devices 320 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the first user device 110, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The first user device 110 of FIG. 3 is illustrated as having a number of components, but any one or more of these components may be omitted or duplicated, as suitable for the application and setting. In some implementations, some or all of the components included in the first user device 110 may be attached to one or more motherboards and enclosed in a housing (e.g., including plastic, metal, and/or other materials). In some implementations, some of these components may be fabricated onto a single system-on-a-chip (SoC) (e.g., an SoC may include one or more electronic processors 300 and one or more storage devices 305). Additionally, in various implementations, the first user device 110 may not include one or more of the components illustrated in FIG. 3, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the first user device 110 may not include a display device 315, but may include display device interface circuitry (e.g., a connector and driver circuitry) to which a display device 315 may be coupled.

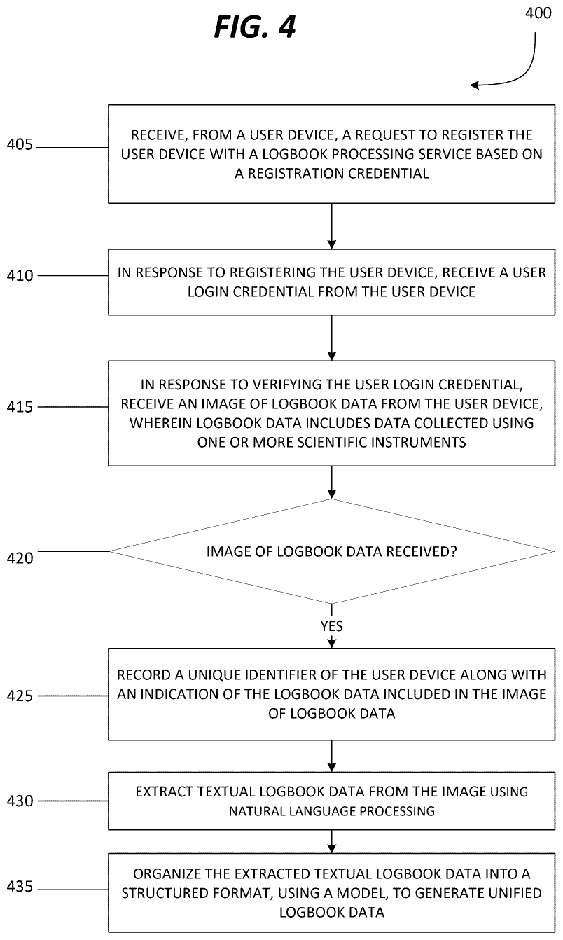

FIG. 4 is a flowchart of an example method 400 for generating unified logbook data. In some implementations, the method 400 is performed by the electronic computing device 105 of the system 100. In some implementations, the method 400 begins at block 405 when the electronic processor 200 receives, from a user device (for example, the first user device 110), a request to register the user device with a logbook processing service based on a registration credential. In some implementations, the logbook processing service is offered when the logbook processing software 215 is executed by the electronic processor 200. A registration credential may be, for example, a registration key, a uniform resource locator (URL), a combination of the foregoing, or the like.

At block 410, the electronic processor 200, in response to registering the user device, receives a user login credential from the user device. A user login credential may be, for example, a registration key, a username, a password, a combination of the foregoing, or the like. In response to verifying the user login credential, the electronic processor 200, at block 415, may receive an image of logbook data from the user device.

In some implementations, the logbook data includes data collected using one or more scientific instruments. The one or more scientific instruments may include, for example, liquid chromatography instruments, gas chromatography instruments, ion chromatography instruments, mass spectrometry instruments, trace elemental instruments (e.g., inductively coupled plasma mass spectrometry, inductively coupled plasma optical emission spectroscopy, atomic absorption, etc.), capillary electrophoresis instruments, spectroscopy instruments, and the like. However, it should be understood that the scientific instruments are not limited to those described herein, and other types of scientific instruments are contemplated. The scientific instruments may include one or more devices. The one or more devices may be physical devices having a serial number, a means of communicating with other external entities, and may include processors, memory, and firmware. The one or more devices may include, for example, sensors, detectors, actuators, spectrometers, spectrograms, oscilloscopes, electrometers, interferometers, and the like.

In some implementations, metadata associated with logbook data is also received by the electronic processor 200 of the electronic computing device 105. In some implementations, the metadata includes a timestamp of when the image of the logbook data is captured, an identifier of the user device used to capture the image of the logbook data, the type of logbook data (for example, typed or handwritten), an indication of whether or not the logbook data is readable, a combination of the foregoing, or the like. In some implementations, the image of logbook data is captured by a camera of the first user device (for example, a camera included in the other input/output (I/O) devices 320). In some implementations, the image of logbook data is captured by a scanner (for example, the scanner 107) and the image of logbook data is transmitted by the scanner to the first user device 110 via the communication networks 125.

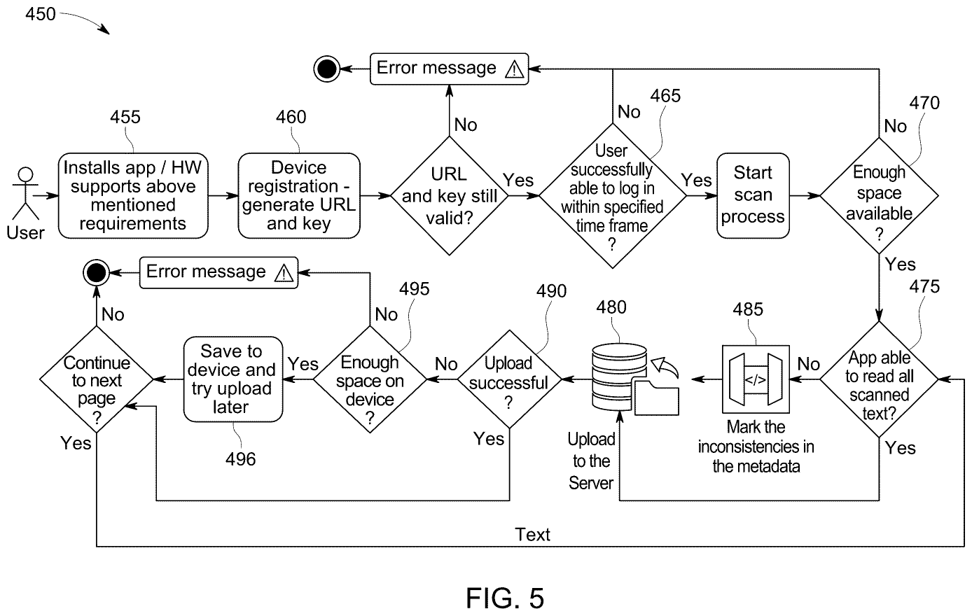

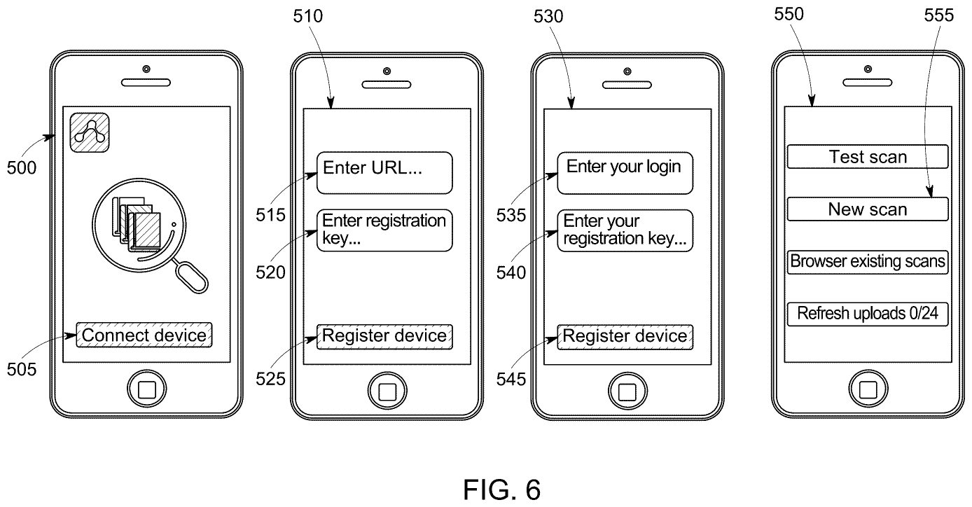

FIG. 5 provides a flowchart of a method 450 for registering a user device and capturing logbook data. In other words, FIG. 5 provides a more detailed flowchart of blocks 405-415 of the method 400 of FIG. 4. In some implementations, at block 455, the first user device 110 may download a logbook software application 325 that allows the first user device 110 to send information (for example, logbook data and/or an image of logbook data) to and receive information (for example, notifications regarding logbook data and/or unified logbook data) from the logbook processing software 215. In some implementations, prior to sending an image of logbook data to the electronic computing device 105, at block 460, the first user device 110 is registered with the logbook processing software 215. For example, FIG. 6 provides an example of graphical user interfaces (GUIs) generated by the electronic processor 300 of the first user device 110 when executing the logbook software application 325. The electronic processor 300 may receive input from a user interacting with the GUIs using any suitable input device (e.g., any of the input devices included in the other I/O devices 320 discussed herein with reference to FIG. 3) and input technique (e.g., movement of a cursor, motion capture, facial recognition, gesture detection, voice recognition, actuation of buttons, etc.). In the first GUI 500, a button 505 is displayed. When the electronic processor 300 receives a selection of the button 505, the electronic processor 300 generates and displays the second GUI 510 via the display device 315. The second GUI 510 includes a first text field 515 and a second text field 520. The electronic processor 300 may receive a uniform resource locator (URL) associated with the logbook processing software 215 and a registration key when a user enters the URL into the first text field 515 and the registration key into the second text field 520. In some implementations, when a selection of a button 525 is received, the URL and registration key entered into the first text field 515 and the second text field 520 may be sent to the electronic computing device 105 by the electronic processor 300. When the electronic processor 200 of the electronic computing device 105 receives the URL and the registration key, the electronic processor 200, executing the identity verification software 220, attempts to verify the URL and the registration key. When the URL and the registration key are verified, the electronic processor 200 registers the first user device 110 with the logbook processing software 215. When the URL and the registration key cannot be verified, an error message may be output by the first user device 110.

In some implementations, when the first user device 110 is registered with the logbook processing software 215, the third GUI 530 is generated and displayed via the display device 315. In some implementations, at block 465, a user may log in to the logbook processing software 215 via the third GUI. For example, the user may enter a login (for example, a username) into a first text field 535 and a registration key into a second text field 540. In some implementations, when the user selects a button 545 the login and registration key entered in to the first text field 535 and the second text field 540 may be sent to the electronic computing device 105. When the electronic processor 200 of the electronic computing device 105 receives the login and the registration key, the electronic processor 200, executing the identity verification software 220, attempts to verify the login and the registration key. When the login and the registration key are verified, the first user device 110 may send information to and receive information from the logbook processing software 215. In some implementations, when the login and the registration key are verified, a fourth GUI 550 is displayed via the display device 315.

In some implementations, when a selection of the button 555 is received by the electronic processor 300, the first user device 110 (for example, a camera included in the other input/output (I/O) devices 320) captures an image of logbook data. In some implementations, when, at block 470, the electronic processor 300 determines that the storage device 305 of the first user device 110 does not have capacity to store the captured image of logbook data an error message is output by the first user device 110.

When, at block 470, the electronic processor 300 determines that the storage device 305 of the first user device 110 does have capacity to store the captured image of logbook data, the electronic processor 300, captures and/or stores the image of logbook data in the storage device 315. In some implementations, the image of logbook data is encoded or encrypted by the electronic processor 300 before it is stored in the storage device 315. In some implementations, at block 475, the electronic processor 300 determines whether the text included in the captured image of logbook data is readable. When the text in the captured image of logbook data is readable, the electronic processor 300, at block 480, sends the captured image of logbook data to the electronic computing device 105. When some or all of the text in the captured image of logbook data is unreadable, the electronic processor 300, at block 485, updates metadata associated with the image of logbook data to include an indication of the text included in the image of logbook data that is unreadable before sending the captured image of logbook data to the electronic computing device 105 at block 480. In some implementations, the electronic processor 300 utilizes one or more natural language processing (NLP) algorithms to determine whether text included in the captured image of logbook data is readable.

In some implementations, at block 490, the electronic processor 300 determines whether the image of logbook data is successfully sent to the electronic computing device 105. In some implementations, the image of logbook data that is sent to the electronic computing device 105 is encoded or encrypted. In some implementations, the electronic processor 300 determines the image of logbook data is successfully sent to the electronic computing device 105 when the electronic processor 300 receives an acknowledgement or confirmation from the electronic computing device 105. In some implementations, when image of logbook data is not successfully sent to the electronic computing device 105, the electronic processor 300, at block 495, determines whether the storage device 305 has the capacity or space to store the captured logbook data. When the storage device 305 does not have the capacity or space to store the captured image of logbook data, the electronic processor 300 may generate and output an error message via the display device 315 and/or other input/output device 320. When the storage device 305 does have the capacity or space to store the captured image of logbook data, the electronic processor 300, at block 496, may store the captured image of logbook data in the storage device 305 temporarily until the captured image of logbook data is successfully sent to the electronic computing device 105. In some implementations, blocks 475-496 are performed for a single image of captured logbook data and blocks 475-496 may be repeated for each captured image of logbook data.

Returning to FIG. 4, in some implementations, at block 420, the electronic processor 200 determines that an image of logbook data is received and, in response, performs the functionality described below in relation to blocks 425-435. At block 425, the electronic processor 200 may record a unique identifier of the user device along with an indication of the logbook data included in the image of logbook data. Maintaining a record of what logbook data was received from what user device maintains the security of logbook data and enables the electronic processor 200 to generate and provide audit trails for logbook data.

At block 430, the electronic processor 200 extracts textual logbook data from the image using natural language processing. In some implementations, the logbook data included in the image received by the electronic processor 200 of the electronic computing device 105 may be handwritten, typed, or a combination of handwritten and typed.

Currently, there is no universal logbook entry standard that would be used in every single lab all around the globe, however, in accordance with various best practices, assumptions can be made as to what type of information an average scientific lab journal contains. In general, the logbook data may include experiment data (sample identification, instrument identification, experiment parameters, etc.), key findings, a date the experiment was performed, or a combination thereof.

Logbook data may also contain general lab journal identification. General lab journal identification may include a lab journal owner identification that clearly identifies the primary owner of the lab journal to establish accountability and ownership (for example, “Lab Journal Owner: Dr. John Smith, Principal Investigator, Department of Biochemistry”). General lab journal identification may also include lab journal reviewer identification that identifies an individual responsible for reviewing the lab journal entries to ensure accuracy and compliance with protocols (for example, “Lab Journal Reviewer: Dr. John Doe, Senior Research Scientist, Quality Assurance”). General lab journal identification may also include a lab journal contributor identification list of all contributors who have made entries in the lab journal, specifying their roles and contributions (for example, “Lab Journal Contributors: 1) Sarah Johnson, Research Assistant: Data collection and analysis. 2) Michael Brown, Graduate Student: Experimental setup and protocol development”). General lab journal identification may also include codes or an abbreviation matrix that provide a matrix of any codes or abbreviations used in the lab journal, including the names of contributors and other frequently used terms, to ensure clarity and consistency (for example, “JS: John Smith,” “AL: Amanda Lee,” “LC-MS: Liquid Chromatography-Mass Spectrometry,” “HPLC: High-Performance Liquid Chromatography,” “RT: Room Temperature,” “MS/MS: Tandem Mass Spectrometry,” “Q Exactive™: Thermo Scientific™ Q Exactive™ Hybrid Quadrupole-Orbitrap Mass Spectrometer”). General lab journal identification may also include a connection and/or relationship to other lab journals to maintain a comprehensive and integrated record of related research activities (for example, “This lab journal is connected to the ‘Protein Expression and Purification Study’ journal maintained by Dr. Emily White. Refer to entries dated Jan. 15, 2023 to Mar. 30, 2023 for related experimental data and findings using the Thermo Scientific™ Dionex™ UltiMate™ 3000 HPLC system”).

Logbook data may also include project information. Project information may include project name and identification data to ensure proper tracking and reference (for example, “Project Name: Enzyme Activity Analysis in Varying pH Conditions,” “Project ID: EA-2023-001,” “Principal Investigator: Dr. Jane Smith,” “Department: Biochemistry,” “Funding Source: National Science Foundation (NSF) Grant #12345678,” “Start Date: Jan. 1, 2023,” “Expected Completion Date: Dec. 31, 2023”).

Logbook data may also include general experiment information. General experiment information may include dates and titles of experiments conducted to maintain an organized and chronological record (for example, “Experiment Title: Effect of pH on Enzyme Activity” and “Date Conducted: Jan. 15, 2023”). In lab journals shared by multiple researchers, general experiment information may also include researcher identification specifying the name of the researcher making each lab journal entry to ensure accountability and traceability (for example, “Entry by: Sarah Johnson, Research Assistant”). The general experiment information may also include a hypothesis and objectives to articulate the hypothesis, overarching goals, and specific aims of the experiment to provide a clear framework for the research (for example, “Hypothesis: Enzyme activity increases with pH up to a certain point before declining” and “Objectives: 1) Determine the optimal pH for enzyme activity. 2) Assess the enzyme's stability across different pH levels”). The general experiment information may also include comprehensive background information to contextualize the experiment within the broader field of study (for example, “Background: Enzymes are biological catalysts whose activity can be influenced by pH. Understanding this relationship is crucial for applications in biotechnology and medicine”). The general experiment information may also include a detailed methodology of thorough protocols, precise calculations, detailed lists of reagents, and descriptions of equipment used, ensuring reproducibility and clarity (for example, “Protocol: “Prepare buffer solutions at pH levels 4, 5, 6, 7, 8, and 9. Incubate enzyme samples at 37° C. Reagents: “Buffer solutions, enzyme solution, substrate solution. Equipment: “pH meter, spectrophotometer, incubator”). The general experiment information may also include observations noting both planned and unexpected events. Observations may include raw data and permanently affixed information, with explicit references to the data's location for ease of access (for example, “Observed a color change indicating enzyme activity at pH 7. Unexpected precipitation observed at pH 9. Data Location: Raw data recorded in lab notebook, page 45”). The general experiment information may also include conclusions drawn from the experimental results and interpretations that contribute to the understanding of the research question (for example, “Conclusions: The optimal pH for enzyme activity was determined to be pH 7. Enzyme activity decreased significantly at pH levels above 8. Future experiments should investigate the enzyme's behavior in more acidic conditions”).

Logbook data may further include specific experiment information. Specific experiment information may include an objective/purpose of the experiment that clearly articulate the aim or purpose of the experiment to provide a focused direction for the research (for example, “The objective of this experiment is to determine the effect of varying pH levels on enzyme activity”). Specific experiment information may include an experimental plan, outline, and/or flow diagram to visualize the experimental process and ensure a systematic approach (for example, “Refer to FIG. 1 for the flow diagram outlining the sequential steps from sample preparation to data analysis”). Specific experiment information may include a step-by-step procedure specifying conditions such as temperature, equipment, and reagents used (for example, “1. Prepare a 0.1 M buffer solution at pH 7. 2. Incubate the enzyme solution at 37° C. for 10 minutes. 3) Add 5 mL of substrate solution to the enzyme mixture”). Specific experiment information may include critical test conditions and/or parameters to ensure the accuracy and reliability of the experiment (for example, “Maintain a constant temperature of 25° C. and a reaction time of 30 minutes for all test samples”). Specific experiment information may include supplementary information that supports the experiment, along with relevant citations to acknowledge sources and provide context (for example, “Refer to Smith et al. (2020) for the standard protocol used in enzyme assays”). Specific experiment information may include observations capturing both planned and unplanned occurrences to provide a complete picture of the experimental process (for example, “Observed a color change from blue to green after 5 minutes, indicating the start of the reaction”). Specific experiment information may include data collection including forms of data, such as raw data, calculated data, and transcribed data, ensuring each type is clearly identified and accurately recorded (for example, raw data, such as, “Initial absorbance readings: 0.45, 0.47, 0.46,” calculated data, such as, “Average absorbance: 0.46 (using the formula A=(A1+A2+A3)/3),” and transcribed data, such as “Data transcribed from lab journal, page 23”). Specific experiment information may include results presented using graphs, tables, figures, and data analysis (for example, “See Table 1 for a summary of enzyme activity levels across different pH conditions. Graph 1 illustrates the correlation between pH levels and enzyme activity”). Print-outs included in the specific experiment information may be permanently affixed in a lab journal to maintain the integrity of the documentation. Specific experiment information may include units of measurement used throughout the experiment to maintain consistency and clarity (for example, “All volumes are measured in milliliters (mL), and temperature is recorded in degrees Celsius (°C.)”). Specific experiment information may include conclusions summarizing the findings of the experiment, indicating whether the objective of the experiment was met, and/or providing insights/suggestions for future experiments to guide subsequent research efforts (for example, “The objective to determine the effect of pH on enzyme activity was met. Results indicate optimal activity at pH 7. Future experiments should explore the enzyme's stability over extended periods”).

Logbook data may also include a comprehensive list of all references cited throughout the lab journal to ensure proper attribution and to facilitate further reading and verification of logbook data (for example, “Thermo Fisher Scientific. (2021). Protocol for High-Fidelity PCR Amplification. Retrieved from https://www.thermofisher.com” and “Thermo Fisher Scientific. (2020). Application Note: Optimizing Enzyme Reactions with Thermo Scientific™ Buffers. Retrieved from https://www.thermofisher.com”). Logbook data may also include intellectual property information related to the experiment, including patents, trademarks, and proprietary methodologies, to protect and manage the intellectual assets (for example, “Patent Pending: Advanced Method for Enhanced Enzyme Activity Using Thermo Scientific™ EnzymeMax™ Buffers in mammal enzymes (Patent Application #123456789)” and “Trademark: Thermo Scientific™ EnzymeMax™—Proprietary enzyme formulation used in the study”). The logbook data may also include a list any supplemental documents referenced in the lab journal to provide a clear connection to additional materials that support the experiment (for example, “Supplemental Document 1: Detailed Protocol for Using Thermo Scientific™ High-Fidelity DNA Polymerase (Document ID: SUPP-001)” and “Supplemental Document 2: Comprehensive Data Analysis Report Using Thermo Scientific™ NanoDrop™ Spectrophotometer (Document ID: SUPP-002)”).

In some implementations, the electronic processor 200, utilizes one or more NLP algorithms included in the logbook processing software 215, to extract the textual logbook data. In some implementations, at block 435, the electronic processor 200 organizes the extracted textual logbook data into a structured format, using a model 225, to generate unified logbook data. For example, the electronic processor 200 stores the extracted text in a data structure (for example, a table) in, for example, the database 108. In some implementations, the database 108 is a structured query language (SQL) database. In some implementations, a template for organizing the extracted textual logbook data into a structured format may be automatically selected or created by the electronic processor 200 based on the textual logbook data. In some implementations, the electronic processor 200 receives a selection of a template to use to organize the extracted textual logbook data into a structured format. In some implementations, the extracted textual logbook data is indexed. Indexing the extracted textual logbook data allows the unified logbook data to be searched more easily. In some implementations, the unified logbook data is editable and accessible to users with the appropriate login credentials.

In some implementations, the electronic processor 200 of the electronic computing device 105, generates, using a model (for example, the model 225) a notification regarding the logbook data based at least in part on the logbook data. The generated notification may identify an organization suggestion for the logbook data, an anomaly in the logbook data, or a potential error associated with the logbook data. In some implementations, a notification regarding an anomaly or potential error may include a suggestion for addressing the anomaly or potential error. In some implementations, the electronic processor 200, may use one or more models, in addition to the model 225, to generate one or more notifications. For example, a first machine learning model may be used to generate notifications regarding organization suggestions for the logbook data, a second machine learning model may be used to generate notifications regarding potential spelling/grammatical errors, a third machine learning model may be used to generate notifications regarding potential sample errors, and a fourth machine learning model may be used to generate notifications regarding anomalies in the logbook data.

In some implementations, the electronic processor 200 determines whether required fields in the logbook data are filled in with the correct data type (for example, textual data or numerical data) and generates a notification when a required field is not filled in (is blank) or is filled in with the wrong data type.

In some implementations, the potential error associated with the logbook data is a sample error, a grammatical error, or a spelling error. Examples of grammatical errors in logbook data for which a notification may be generated include incorrect verb usage, missing or misplaced punctuation, incorrect sentence structures (for example, sentence fragments or run-on sentences), incorrect usage of words (for example, using “there” when “their” is the correct term).

A sample error may be a potential contamination issue, an equipment failure or malfunction (for example, a malfunction of the scientific instrument used to collect the logbook data), a sample degradation risk, a quality issue, or a delay or issue in the experimental process. For example, the model 225 may determine that a potential contamination issue exists for a sample included in the received logbook data based on historical data associated with similar samples that resulted in contamination. The model 225 may determine that an equipment failure or malfunction occurred based on patterns identified in samples in previous instances where equipment failure occurred. The model 225 may determine a sample degradation risk by analyzing variables including, for example, temperature of a sample, storage duration of a sample, and handling methods for a sample. The model 225 may determine a quality issue based on correlations between specific sample characteristics and subsequent quality control results. The model 225 may determine a delay or issue in the experimental process by analyzing historical data related to experiments similar to the experiment associated with the received logbook data.

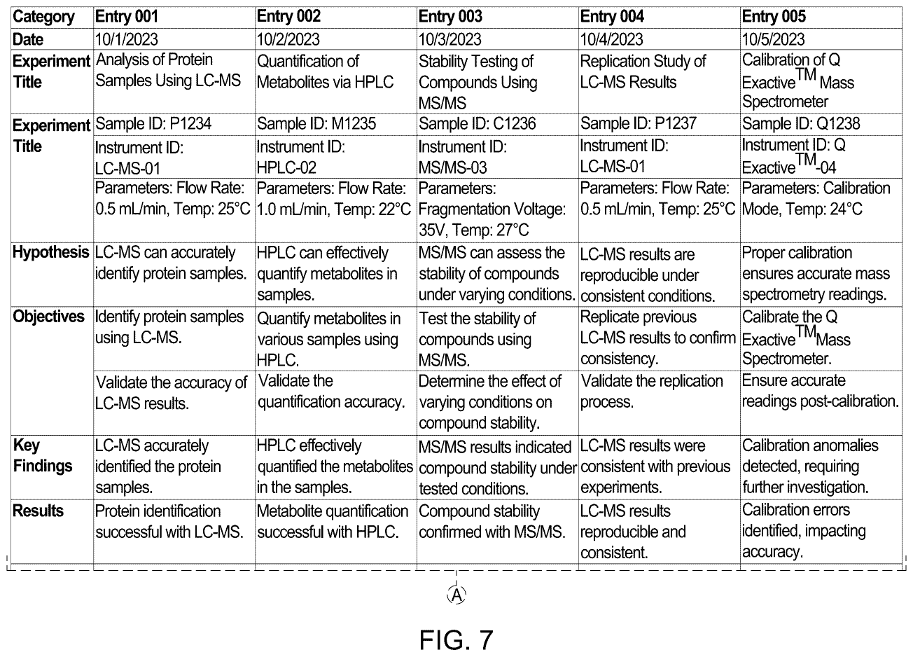

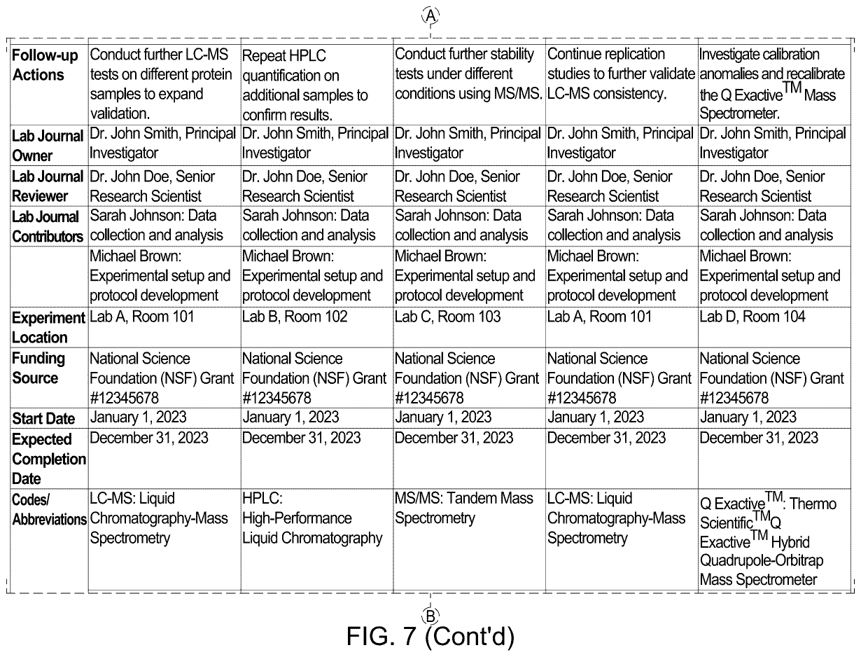

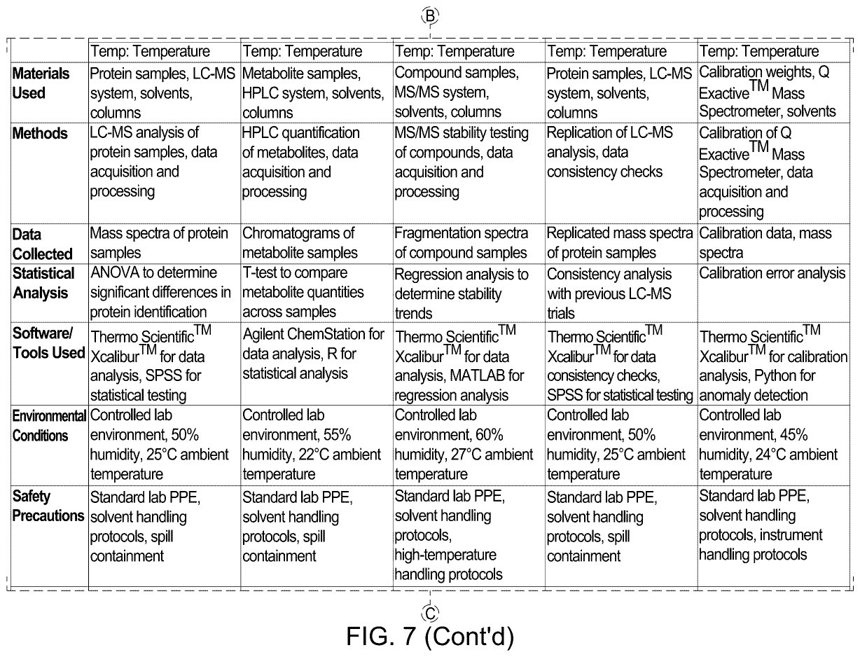

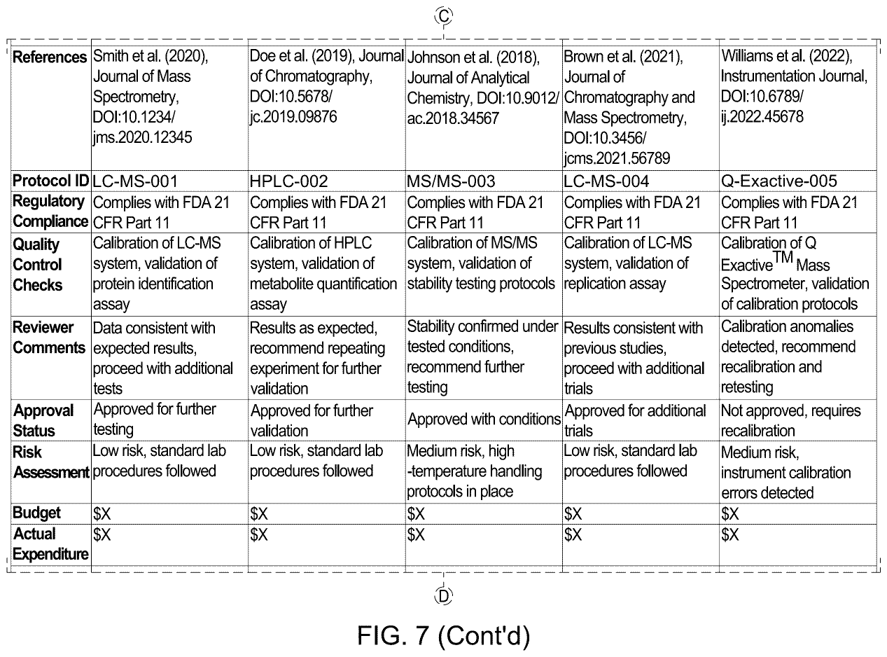

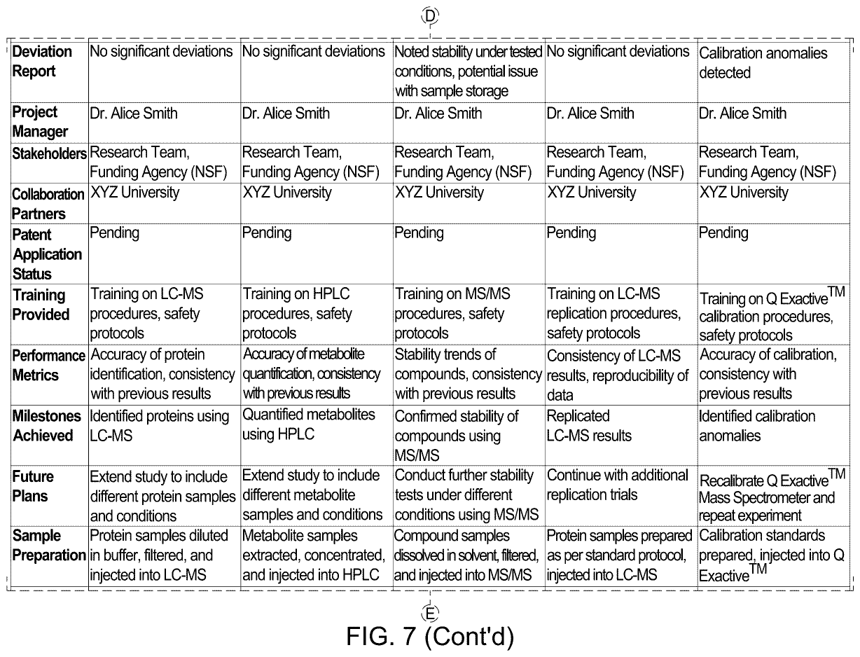

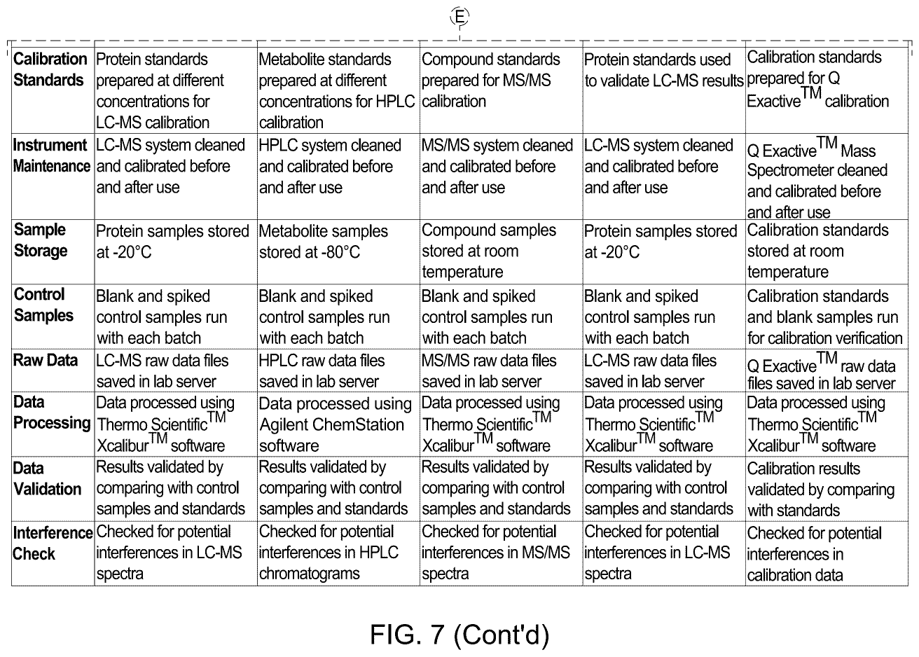

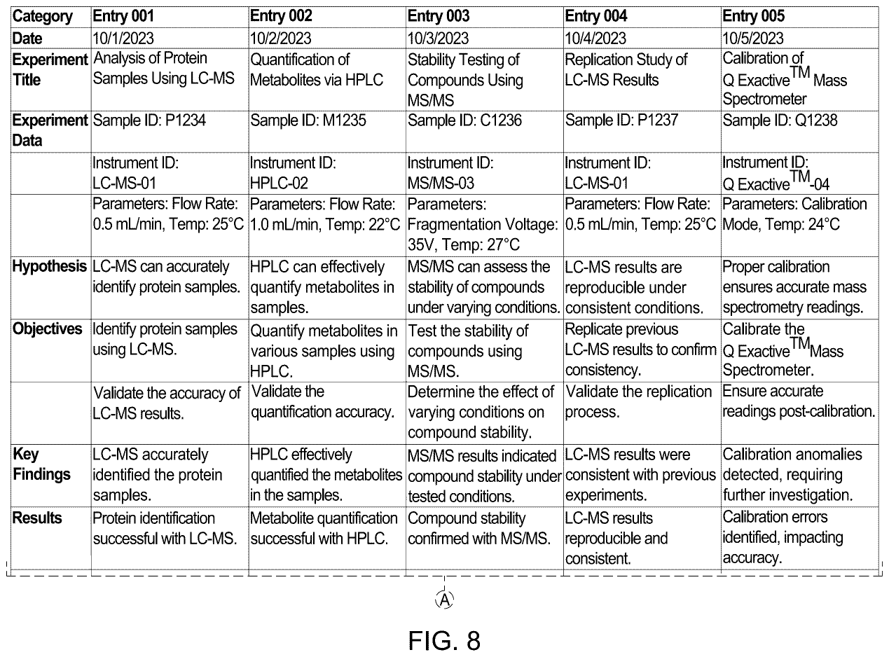

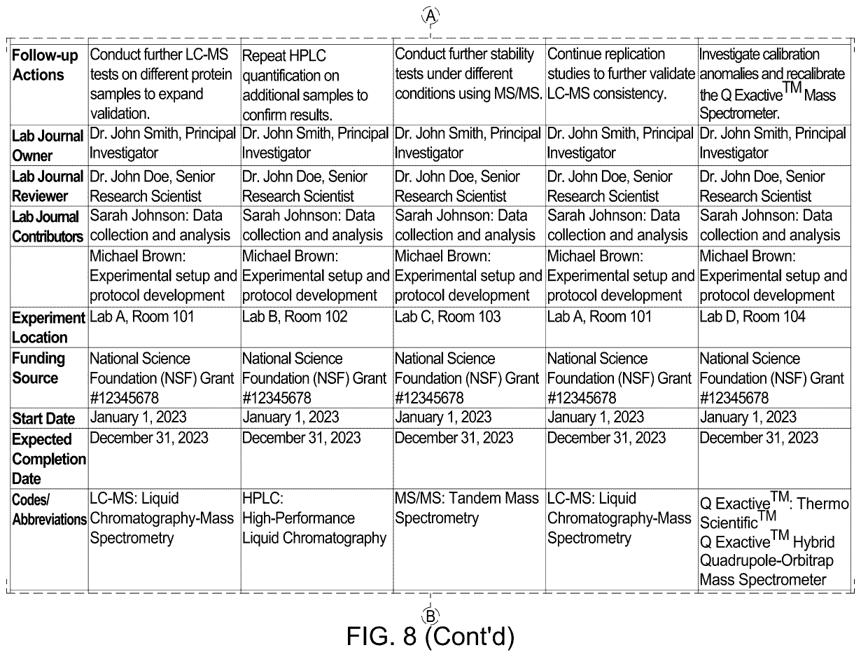

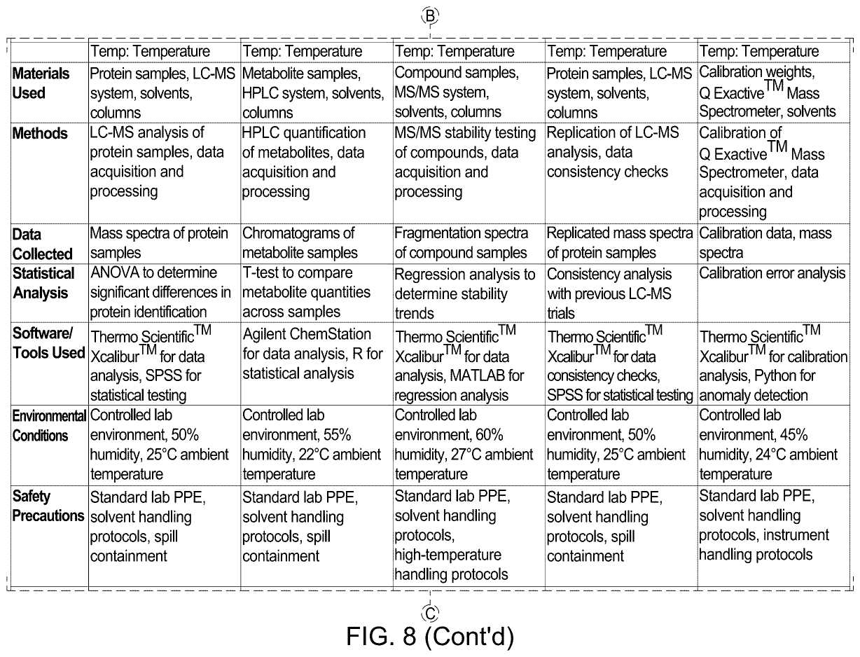

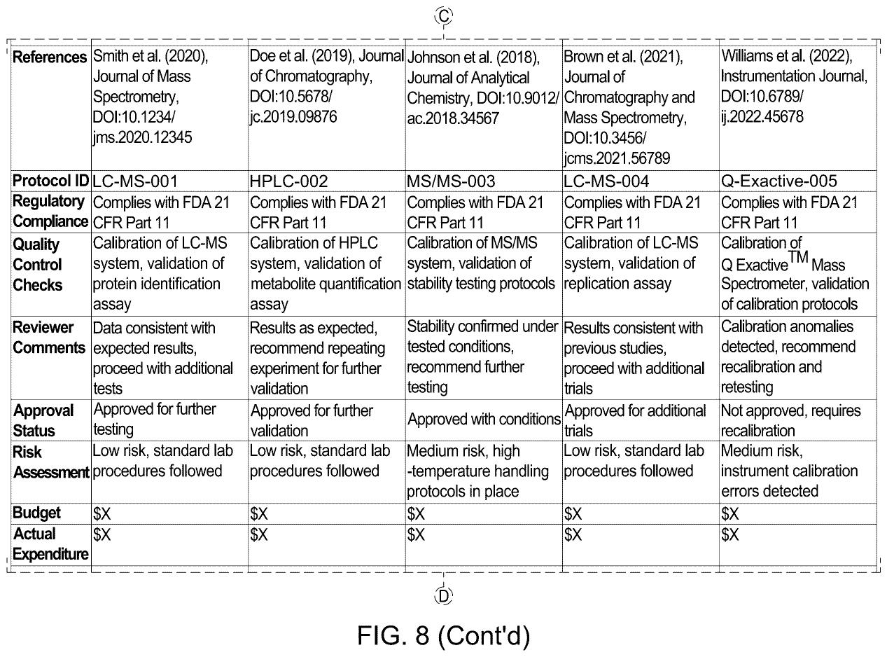

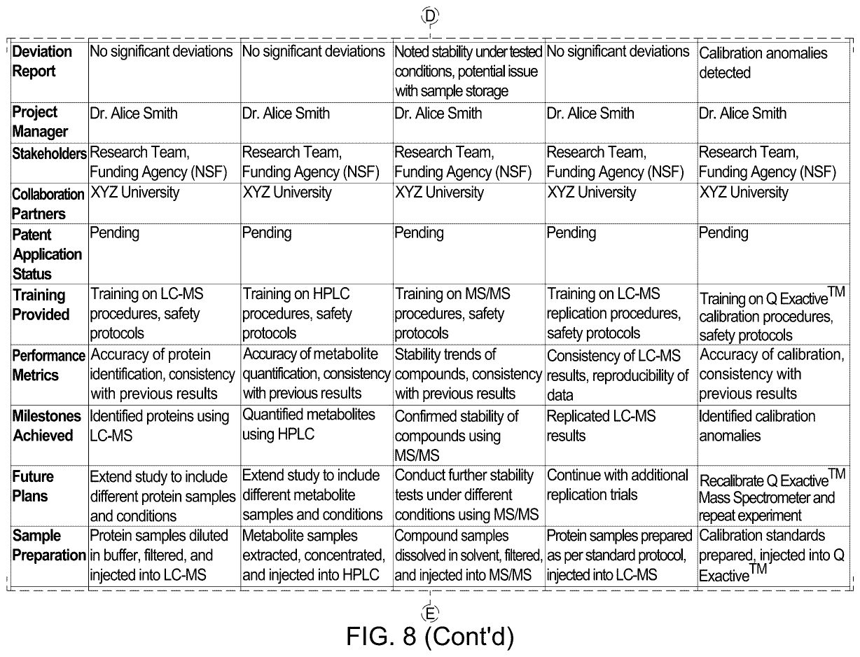

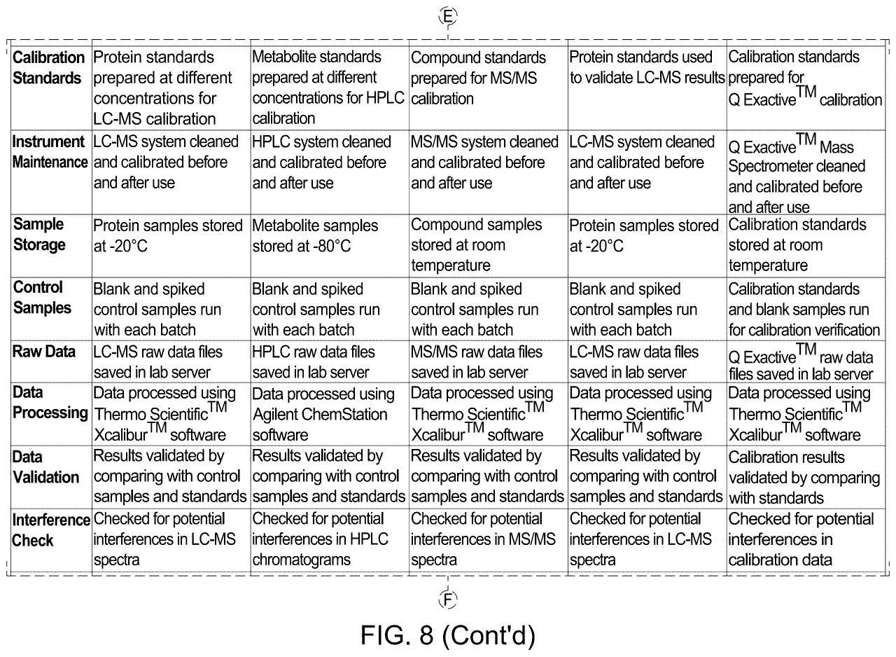

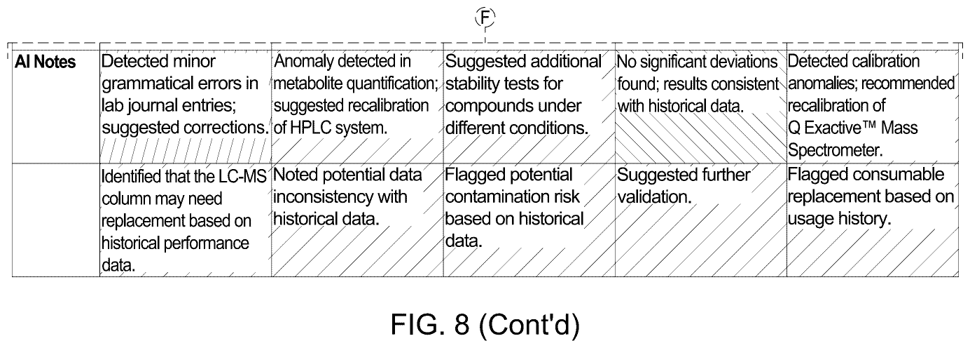

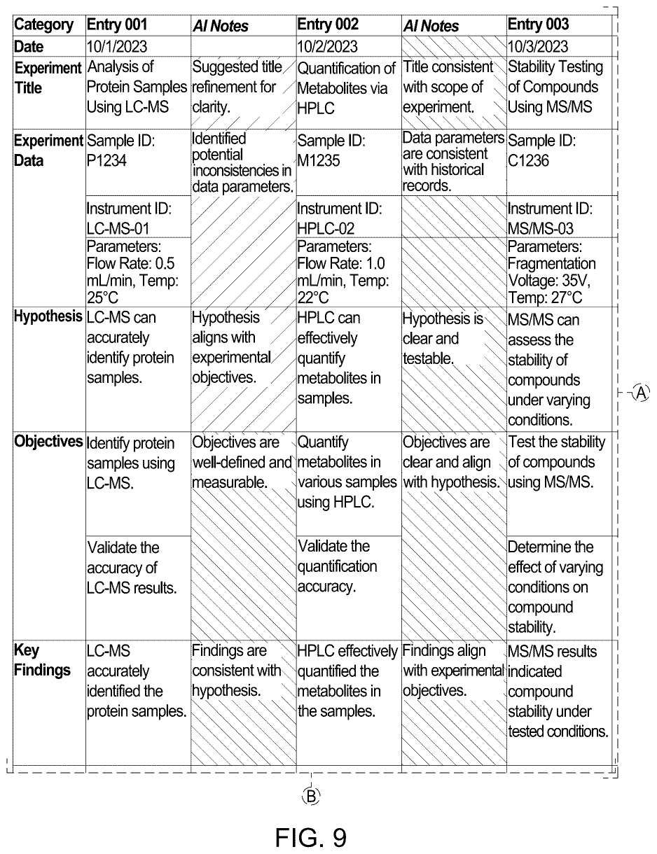

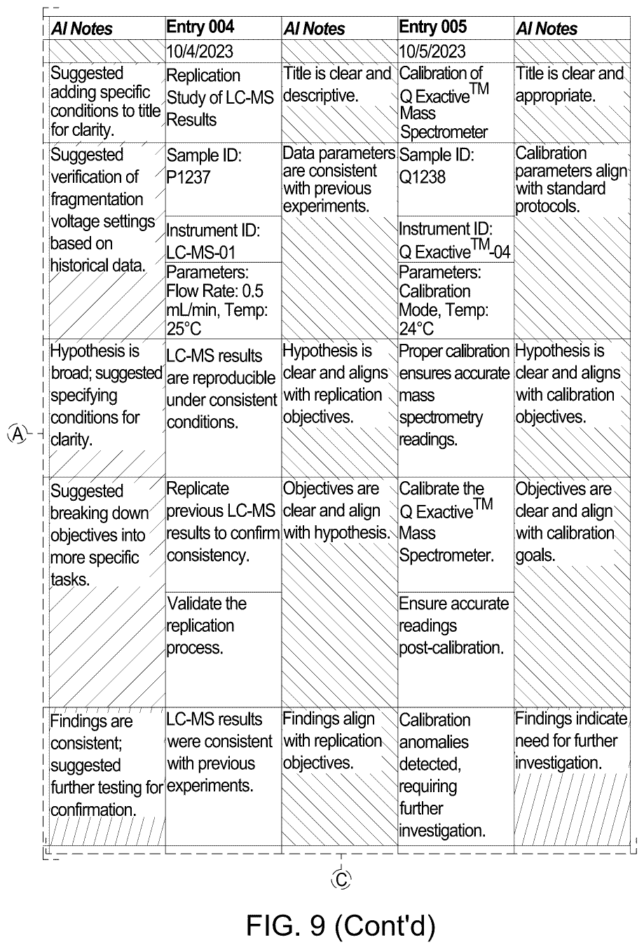

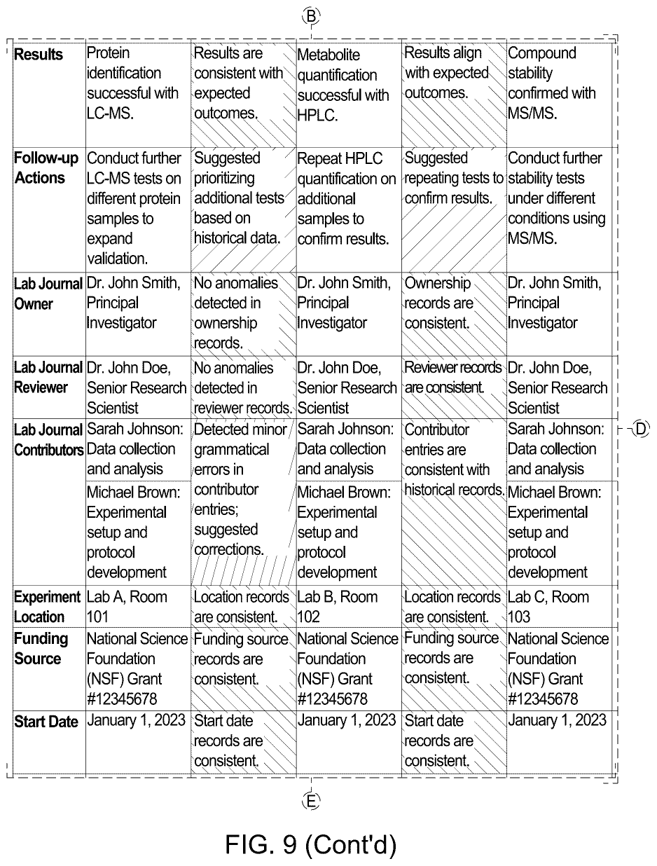

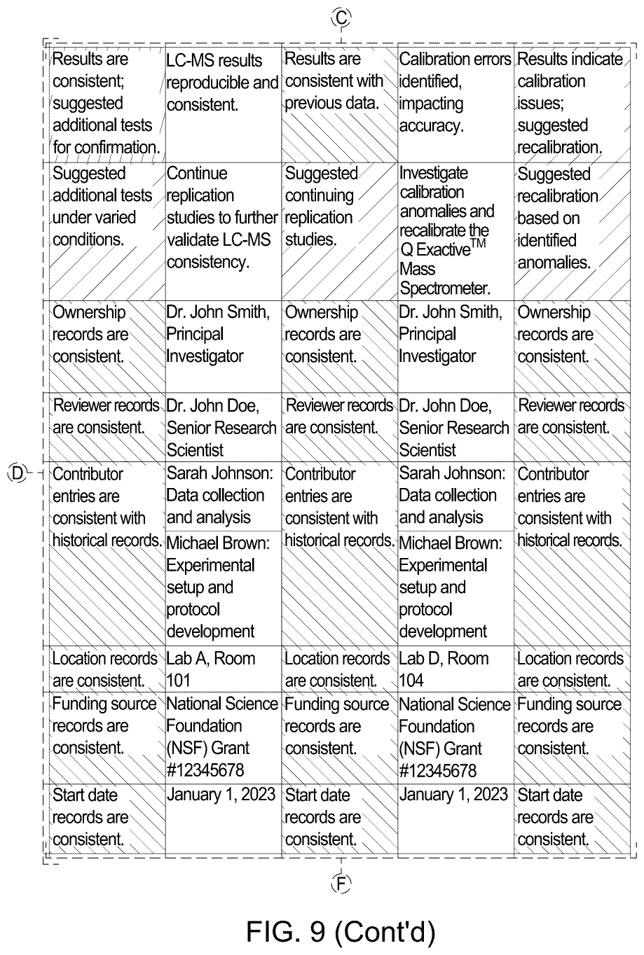

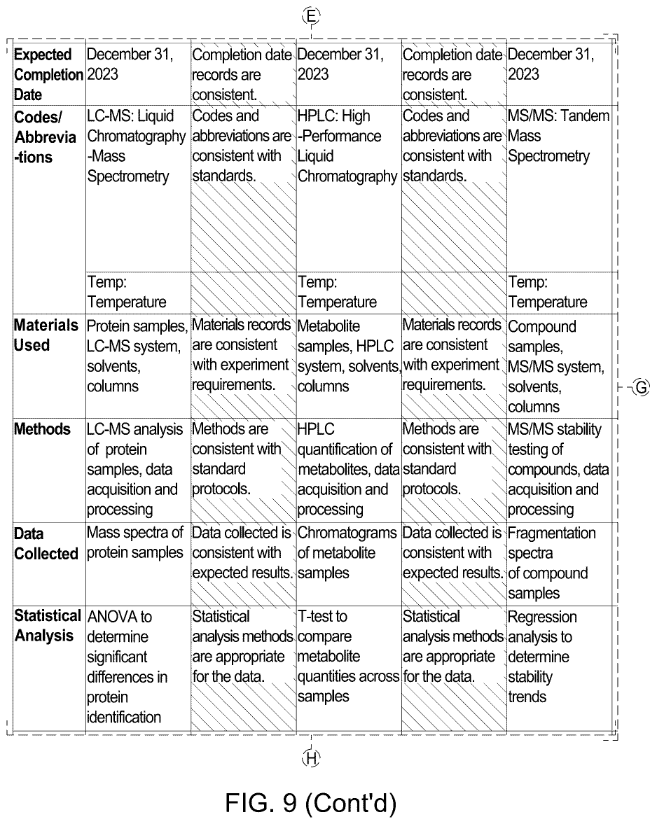

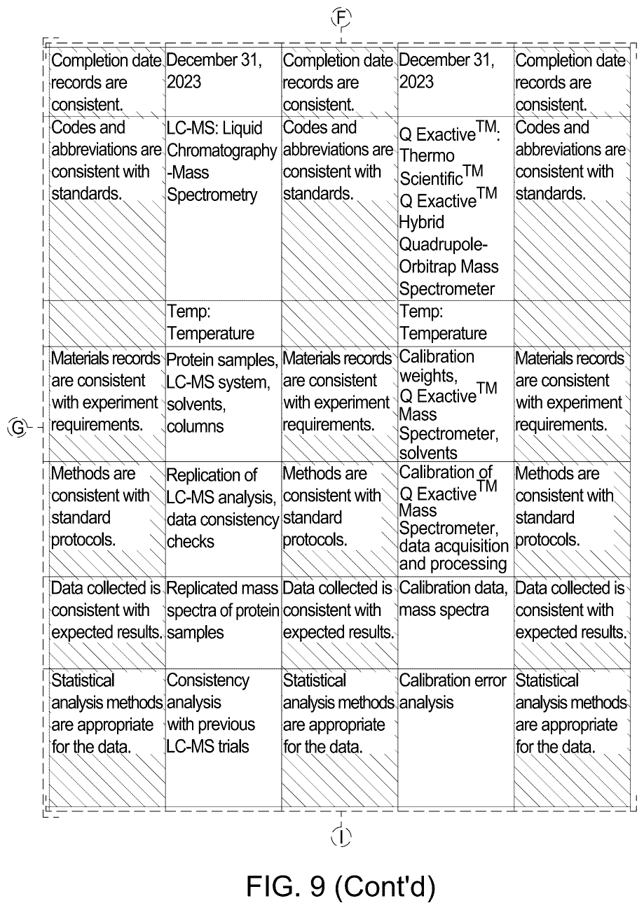

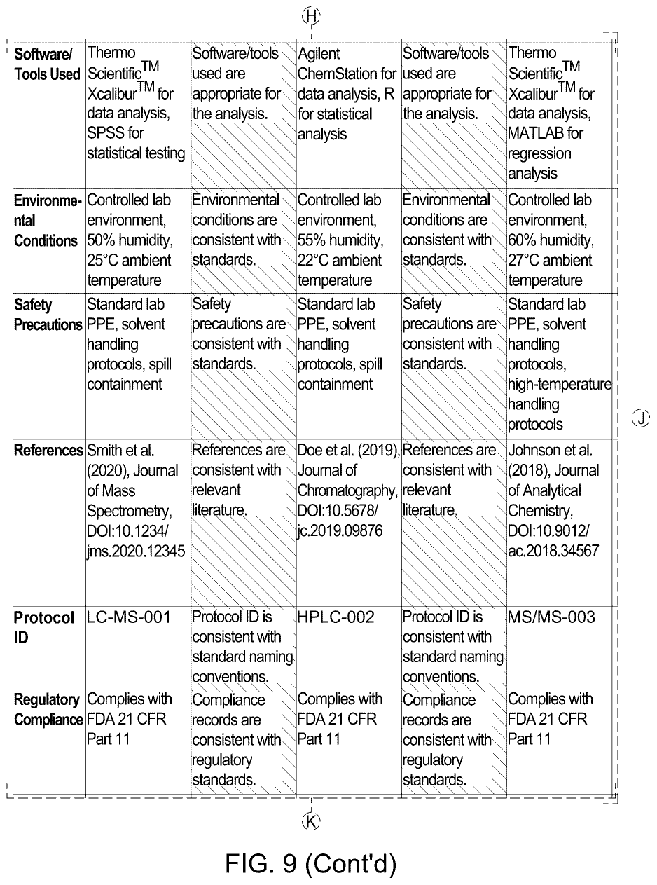

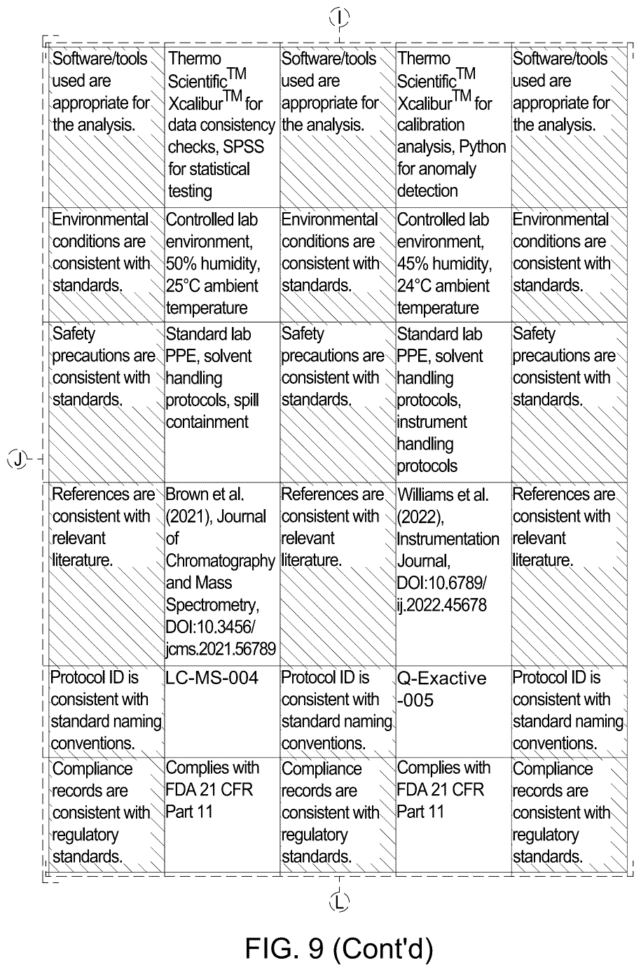

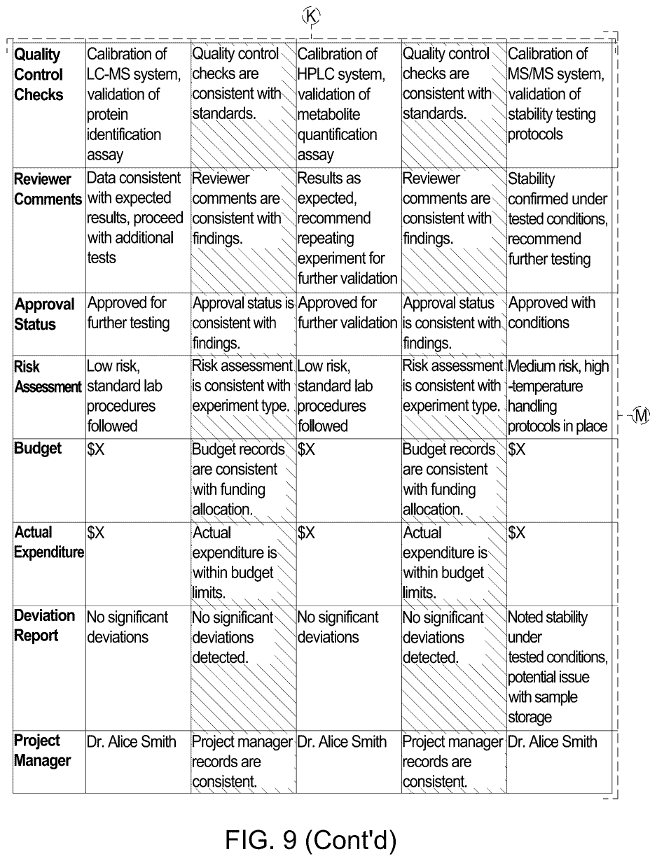

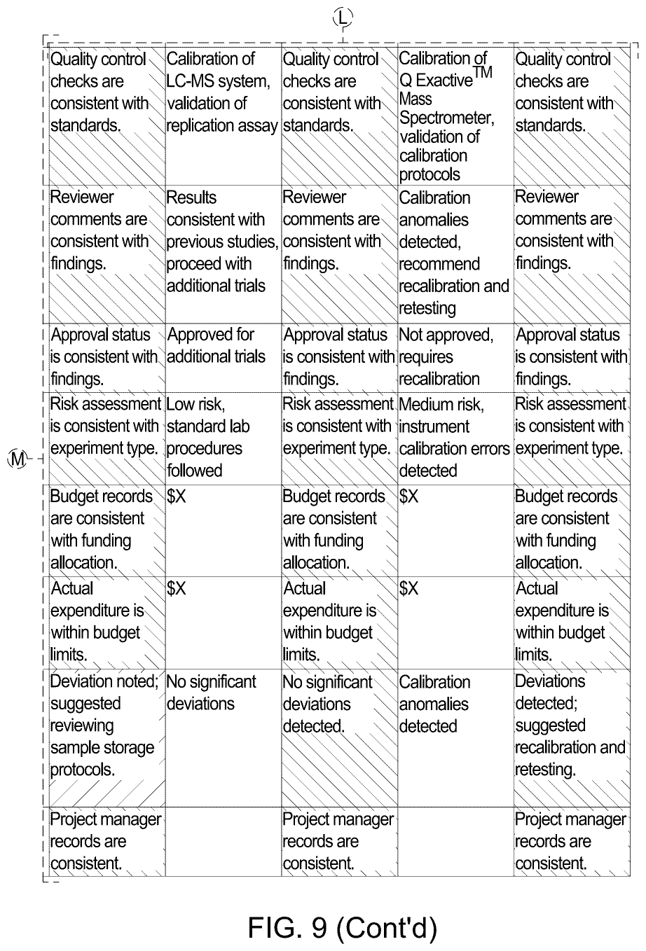

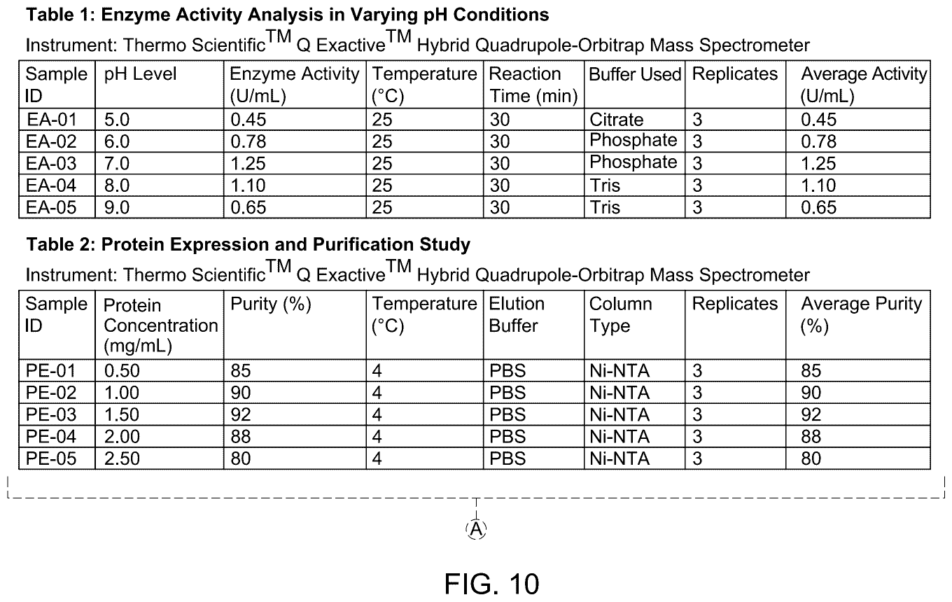

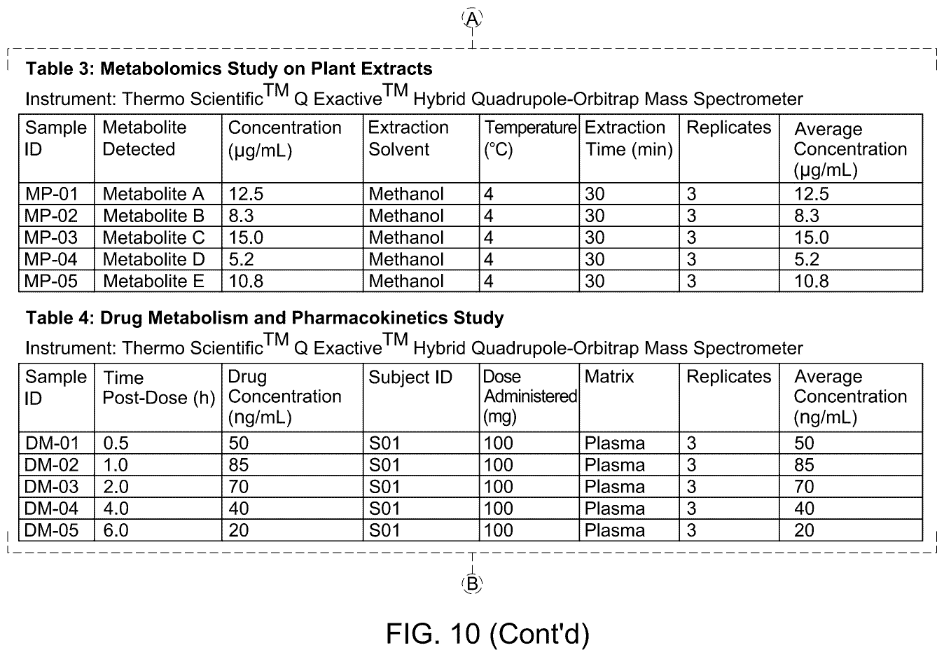

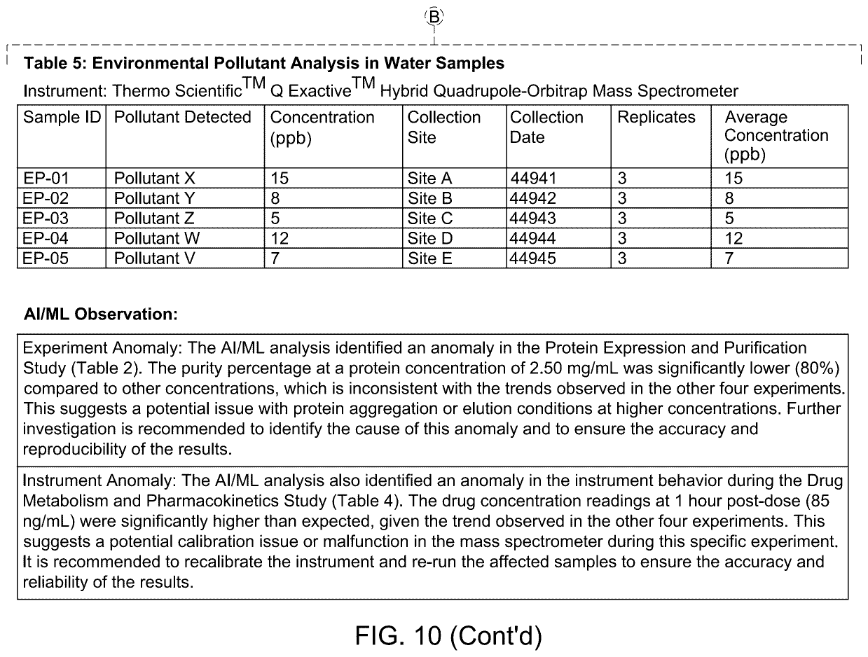

FIGS. 7-10 are an illustrative example of unified logbook data and notifications that may be generated regarding logbook data according to some implementations. FIG. 7 is an example of unified logbook data. FIG. 8 includes an example of suggestions or notifications that the model 225 may determine for entries in the logbook data. The suggestions or notifications the model 225 generates for each entry are included in the final two rows included in the table of FIG. 8. FIG. 9 is an example of suggestions or notifications that the model 225 may determine for each category of each entry in the logbook data. FIG. 10 includes several tables of experiment data that may be generated by the model 225. FIG. 10 also includes notifications the model 225 may generate based on the experiment data.

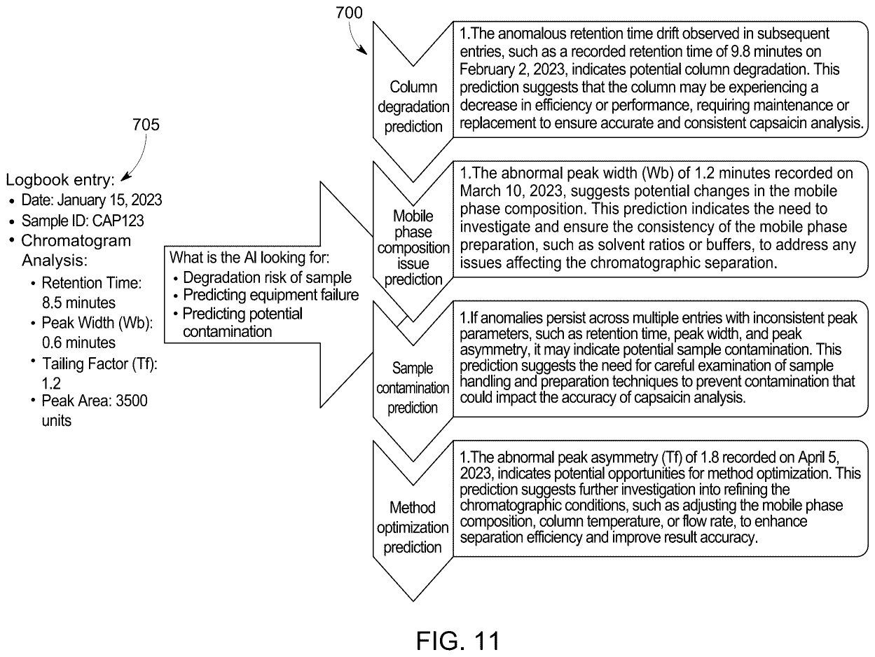

FIG. 11 is a graphical illustration of sample errors 700 that the model 225 may determine for a logbook entry 705 included in the received logbook data. In the example illustrated in FIG. 11, the logbook entry is a sample measurement recorded by a user attempting to determine an amount of capsaicin included in a set of samples.

In some implementations, an anomaly in the logbook data is experimental results that deviate from historical data or established norms by a predetermined threshold, outliers in sample characteristics (for example, extreme pH values or unusually high concentrations), unusual patterns in timing or frequency of experimental procedures or sample preparation steps, aberrations in recorded measurements or observations (for example, aberrations that indicate potential errors or anomalies), and sudden changes in behavior of samples (for example, sudden changes that may indicate underlying issues).

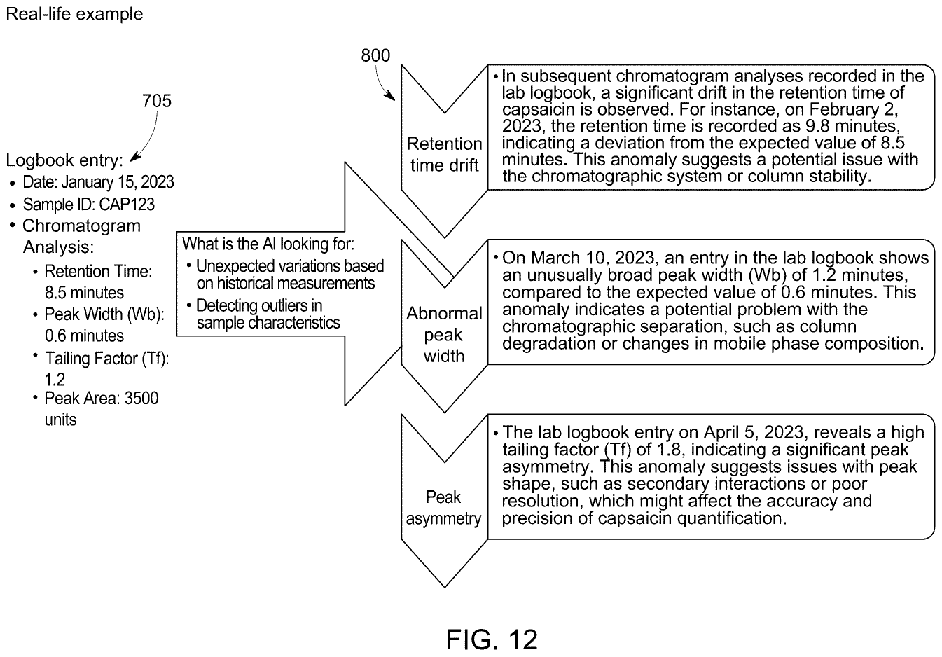

FIG. 12 is a graphical illustration of anomalies 800 that the model 225 may determine for a logbook entry 705 included in the received logbook data. Like in the example illustrated in FIG. 11, in the example illustrated in FIG. 12, the logbook entry is a sample measurement recorded by a user attempting to determine an amount of capsaicin included in a set of samples.

In some implementations, the electronic processor 200 generates unified logbook data and/or organization suggestions for the logbook data by categorizing logbook entries in the logbook data based on, for example, experiment type, sample source, or parameters being tested; organizing logbook entries included in the logbook data based on, for example, project names, research areas, or experimental stages; tagging logbook entries with relevant labels to enable quick search and retrieval; grouping logbook entries in the logbook data based on, for example, experimental protocols or standard operating procedures (SOPs); and identifying and extracting key information from logbook entries (for example, sample identifiers, experiment dates, and experiment conditions) in the logbook data for indexing and analysis.

An organization suggestion for the logbook data may be, for example, that a new data type has been determined in the logbook data and adding a column associated with the data type to the table of logbook data is recommended. In another example, an organization suggestion for the logbook data may be recommending tagging logbook data with a particular label.

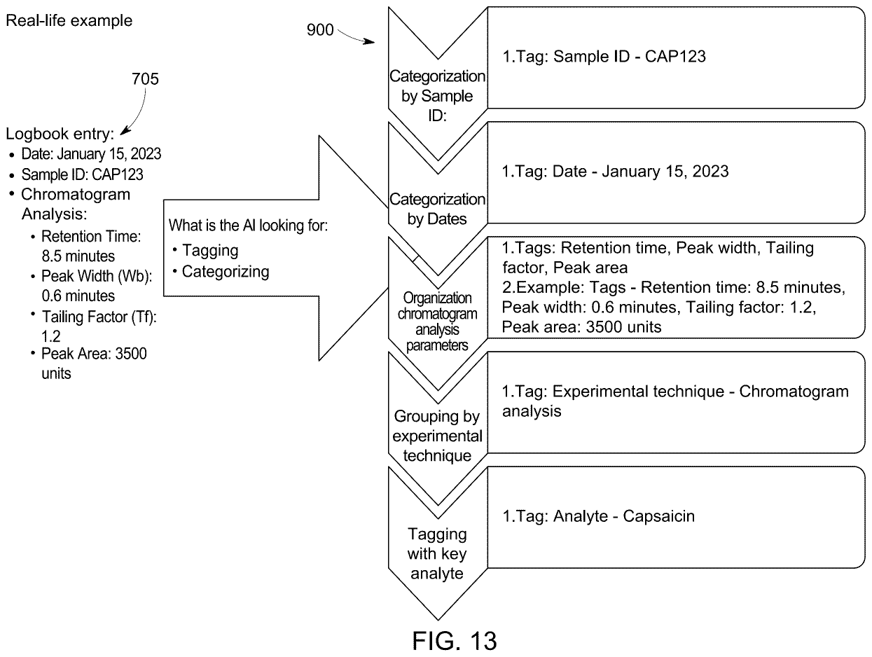

FIG. 13 is a graphical illustration of organization actions/suggestions 900 that the model 225 may determine for a logbook entry 705 included in the received logbook data. Like in the examples illustrated in FIG. 11 and FIG. 12, in the example illustrated in FIG. 13, the logbook entry 705 is a sample measurement recorded by a user attempting to determine an amount of capsaicin included in a set of samples.

In some implementations, the electronic processor 200 sends, to the first user device 110, the unified logbook data and/or the notification regarding the logbook data for display on a display device (for example, the display device 315). It should be understood that the electronic processor 200 may send multiple notifications regarding the logbook data to the first user device 110.

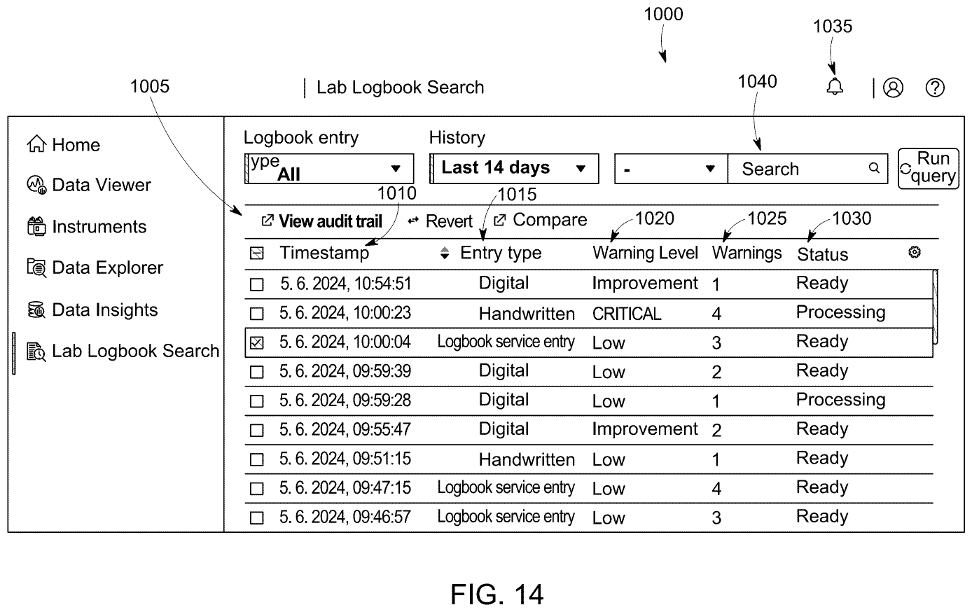

FIG. 14 is an example GUI 1000 that may be displayed on the display device 315 of the first user device 110. In the GUI 1000, a table 1005 is displayed. Each row of the table 1005 represents a logbook entry. Column 1010 includes a time when the logbook entry was received by the electronic computing device 105. Column 1015 includes an indication whether the logbook entry was originally digital and created without using the logbook processing service, hand written, or digital and created using the logbook processing service. Column 1020 includes an indication of a warning level associated with the notifications generated for the logbook entry. In the example illustrated in FIG. 14, the warning level is at least one selected from the group consisting of “improvement,” “critical,” and “low.” In some implementations, “critical” is the highest warning level and “improvement” is the lowest warning level. In some implementations, when there are multiple warnings or notifications associated with a variety of warning levels, the highest warning level associated with a notification generated for the logbook entry is displayed in the column 1020. Column 1025 includes a number of warnings or notifications that are associated with a logbook entry. Column 1030 includes an indication as to whether the logbook entry is “ready” or “processing.” A logbook entry may be “ready” when the electronic processor 200 has performed, for the logbook entry, the functionality described in relation to blocks 430 and 435 and, optionally, generated applicable notifications for the logbook entry. In some implementations, the electronic processor 300 of the first user device 110 receives a selection of a logbook entry when a user selects a checkbox associated with the logbook entry. In some implementations, an icon (for example, the icon 1035) may indicate when a new notification is received by the first user device 110 regarding logbook data. In some implementations, the table 1005 of logbook entries maybe searched to find one or more specific logbook entries when the electronic processor 300 receives one or more search terms entered into a text field (for example, the text field 1040).

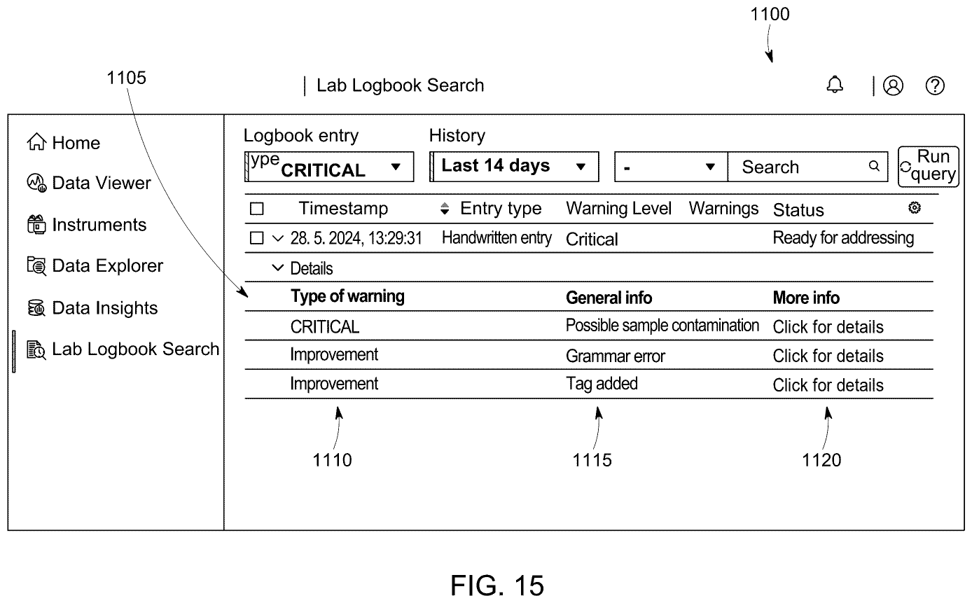

In some implementations, when the electronic processor 300 of the first user device 110 receives a selection of a logbook entry, the electronic processor 300 displays details regarding the selected logbook entry. FIG. 15 is an example GUI 1100 displaying details regarding a logbook entry. The GUI includes a table 1105. Each row included in the table 1105 represents a notification associated with a logbook entry. Column 1110, like column 1020 described above, includes a warning level associated with a notification. Column 1115 includes a brief description of the warning or notification. Column 1120 includes a link that, when selected, causes the electronic processor 300 to display a GUI that a user may interact with to take an action based on the notification. For example, the electronic processor 300 may receive a selection to accept a proposed change associated with a notification, a selection to reject a proposed change associated with a notification, or other input based on the notification (for example, manual adjustment of the logbook entry).

In some implementations, the electronic processor 200 receives feedback from the first user device 110. In some implementations, the feedback includes whether an action was taken based on the notification and a type of action (for example, accept a proposed change, reject a proposed change, or the like) taken based on the notification. Based on feedback received from the one or more user devices included in the system 100, the electronic processor 200 may retrain the model 225, when the model 225 is a machine learning model.

In some implementations, the electronic processor 200 records the notification and action taken based on the notification for audit purposes. In some implementations, the electronic processor 200 also records when logbook data is received/uploaded, deleted, edited, downloaded, or archived. The electronic processor 200 may also record what user uploaded, deleted, edited, downloaded, or archived logbook data. The electronic processor 200 may also record what logbook data is uploaded, deleted, edited, downloaded, or archived. The electronic processor 200 may also record which user device is used to upload, delete, edit, download, or archive logbook data. In some implementations, a list of notifications and actions taken based on the notifications may be sent to the first user device 110 and displayed via the display device 315.

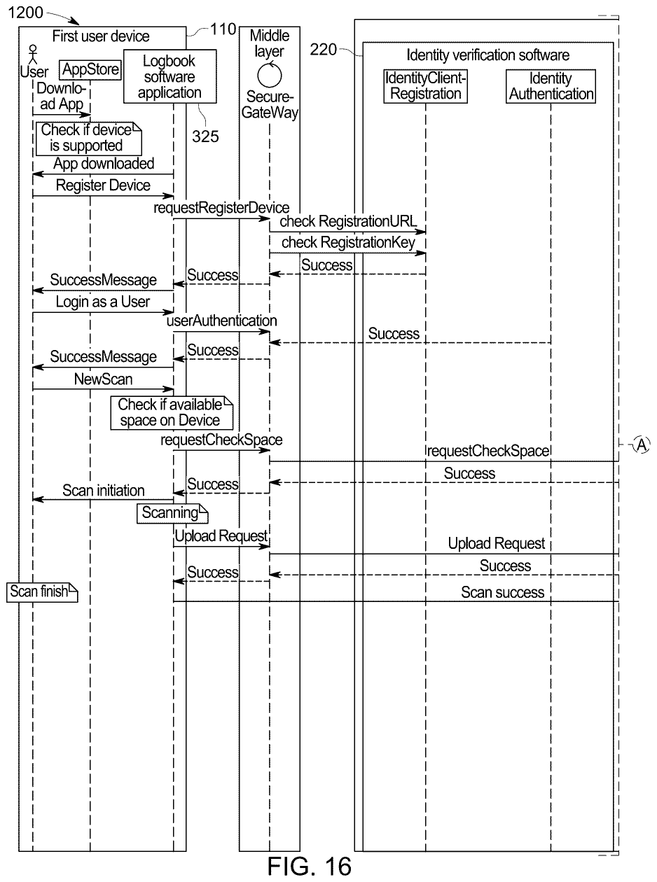

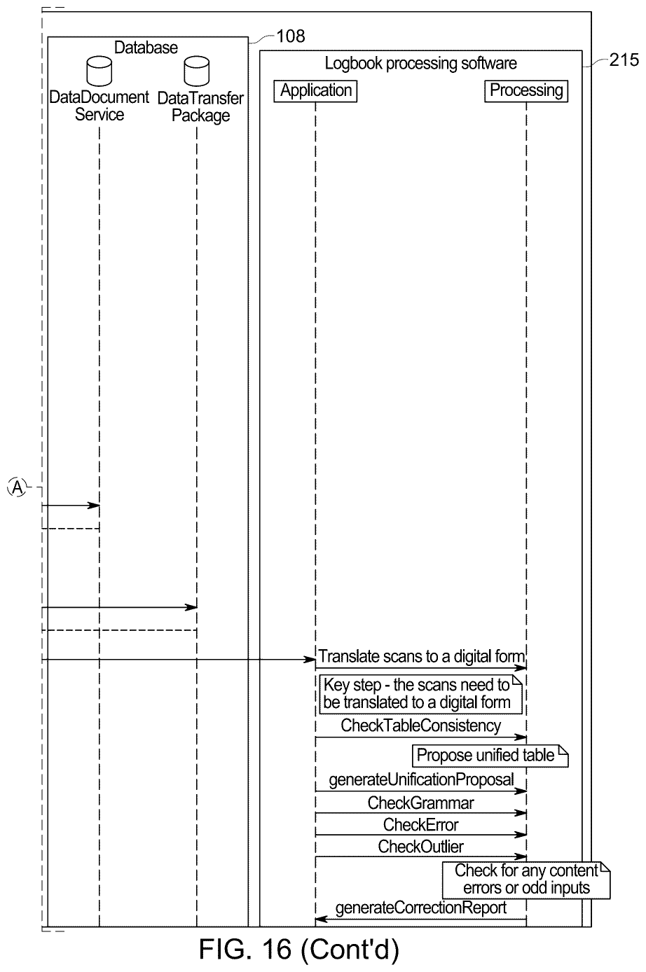

FIG. 16 is a swim lane diagram 1200 illustrating communications sent between physical and software components included in the system 100 when the functionality described herein is performed. In some implementations, as illustrated in FIG. 16, communications to and from the first user device 110 (and any other user device included in the system 100) may be, for security purposes, routed through a secure software module included in the storage device 205 of the electronic computing device 105.

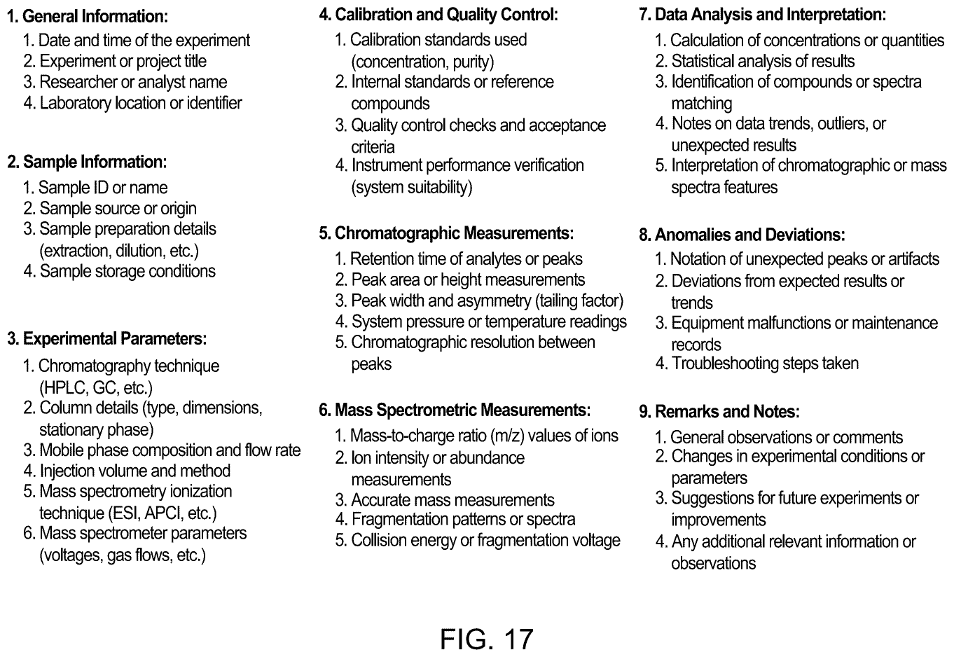

In some implementations, the model 225 is a machine learning model that is trained on training data including a plurality of annotated logbook entries (training data examples). FIG. 17 provides an example list of the data that may be included in an annotated logbook entry of the training data. It should be understood that, in some implementations, an annotated logbook entry may include fewer, additional, or different data compared to the data that is included in FIG. 17. In some implementations, the model 225, may update the notifications and organized data that it produces as further logbook data is received. For example, based on further logbook data, the model 225 may determine that a logbook entry that it previously analyzed and generated a notification regarding an anomaly for does not in fact include an anomaly. In this example, the electronic processor 200 may delete or recall the notification generated regarding the anomaly.

Examples of the types of machine learning models that may be used to perform the functionality performed by the model 225 described herein include Supervised Learning Models, Unsupervised Learning Models, Deep Learning Models, and Natural Language Processing (NLP) Models. Supervised Learning Models, such as Support Vector Machines (SVM), Decision Trees, and Random Forests, may be executed to classify logbook entries and detect anomalies based on labeled training data. SVMs may be used for classification tasks, such as categorizing logbook entries into different types (for example, experiment type, sample type, or the like). SVMs are available to use with open-source libraries such as Scikit-learn. Random Forests may be executed to perform both classification and regression tasks. For example, predicting the likelihood of sample contamination based on historical data. Random Forests are available in open-source libraries such as Scikit-learn. Decision Trees may be executed to create decision rules to detect anomalies or errors in logbook entries. These are also available in Scikit-learn and other open-source libraries.

Unsupervised Learning Models may be clustering algorithms like K-means or Density-Based Spatial Clustering of Applications with Noise (DBSCAN) may be utilized to identify unusual patterns in logbook data or group similar logbook entries without labeled data. K-means clustering may be used to group similar logbook entries together, which helps in identifying patterns or outliers. DBSCAN may be executed to identify noise and outliers in logbook data. K-means clustering and DBSCAN algorithms are available in Scikit-learn.

Deep Learning Models may include Convolutional Neural Networks (CNNs) and/or Recurrent Neural Networks (RNNs), including Long Short-Term Memory (LSTM) networks, may be executed to perform complex tasks such as handwriting recognition from images of logbook data or sequential data analysis. CNNs may be executed to perform image recognition tasks, such as identifying handwritten text in scanned logbook images. RNNs may be executed to perform sequential data analysis, such as tracking changes in experimental procedures over time. Libraries such as TensorFlow and PyTorch offer CNN and RNN implementations.

Natural Language Processing (NLP) Models may include transformer-based models such as Bidirectional Encoder Representations from Transformers (BERT) or Generative Pre-trained Transformer (GPT) may be executed to extract textual data from logbook entries and understand context in order to identify grammatical errors in logbook data or generate organization suggestions for the logbook data. BERT may be executed to understanding the context of logbook entries, identify grammatical errors, and generate organizational suggestions, and the like. BERT is available through the Hugging Face library. GPT may be executed to generate text-based suggestions and corrections. GPT models are available via the OpenAI API.

In order to train the machine learning model(s) that may be executed to perform the functionality performed by the model 225 described herein, the electronic processor 200 may utilize Annotated Logbook Entries, Synthetic Data Generation, Transfer Learning, and/or Active Learning. Training data may include a large corpus of annotated logbook entries, where each entry is labeled with information such as sample errors, anomalies, grammatical errors, and organizational tags. For example, training data may include a dataset containing logbook entries with labels indicating sample errors, anomalies, and organizational tags. Logbook entries may be manually annotated by domain experts. To, for example, augment training data, synthetic logbook entries may be generated using data augmentation techniques. Utilizing synthetic logbook entries may ensure the model being trained is exposed to a wide variety of potential logbook scenarios. For example, data augmentation techniques may be utilized to generate additional logbook entries by slightly modifying existing entries (for example, by changing dates, sample IDs, or the like). Using transfer learning, pre-trained models on large, generic datasets can be fine-tuned on specific logbook data to improve performance and reduce training time. For example, a pre-trained BERT model may be fine-tuned on a specific dataset of logbook entries to improve its performance on domain-specific tasks. Using active learning, a machine learning model may be trained iteratively by querying the most informative samples from logbook data, annotate the samples, and add the samples to the training set. For example, a model may be iteratively trained by selecting the most informative logbook entries to annotate, thereby improving the model's performance with fewer labeled training data examples.

In some implementations, the electronic processor 200 may pre-process data input to a model (for example, the model 231) to enhance the performance of the model. Pre-processing logbook data may include data cleaning, text normalization, tokenization, feature extraction, and dimensionality reduction. Data cleaning involves removing noise (for example, removing duplicates), correcting spelling errors, and standardizing formats (for example, units of measurement) within the logbook data to ensure consistency. Data cleaning techniques may be implemented using libraries like Pandas in Python. Text normalization involves converting all text to a uniform case (for example, lowercase), removing punctuation (for example, expanding contractions (for example, changing “don't” to “do not”)), and handling special characters. Text normalization may be implemented using open-source natural language processing (NLP) libraries like NLTK or SpaCy. Tokenization involves breaking down text into individual tokens (for example, words or subwords) that can be processed by NLP models. Tokenization software is available in libraries like NLTK, SpaCy, and Hugging Face. Feature extraction involves extracting relevant features from the textual data. Features may include term frequency-inverse document frequency (TF-IDF) scores, part-of-speech tags, and named entities. Feature extraction may be performed using libraries like Scikit-learn, SpaCy, and NLTK. Dimensionality reduction involves using techniques such as Principal Component Analysis (PCA) to reduce the dimensionality of feature space of logbook data, making logbook data more manageable for machine learning models. PCA and other dimensionality reduction techniques are available in Scikit-learn.

In some implementations, the electronic processor 200 generates comprehensive reports summarizing key findings, trends, and anomalies identified in logbook data. Automated report generation may be implemented using open-source libraries like ReportLab for generating portable document format (PDF) reports. In some implementations, the electronic processor 200 continuously monitors incoming logbook data for critical issues or deviations and generates alerts for output to relevant personnel in real-time. Real-time monitoring may be implemented using open-source tools like Apache Kafka for stream processing. In some implementations, the electronic processor 200 uses historical logbook data to predict future outcomes, such as potential equipment failures or sample degradation risks. Predictive analytics may be implemented using open-source libraries like Scikit-learn and TensorFlow. In some implementations, the electronic processor 200 generates recommendations for optimizing experimental procedures or improving data quality based on historical data and best practices. Such recommendations may be implemented using open-source libraries like Surprise or TensorFlow. In some implementations, the electronic processor 200 integrates logbook data with other data sources, such as laboratory information management systems (LIMS), to provide a holistic view of the experimental processes and outcomes. Data integration may be achieved using open-source Extract, Transform, Load (ETL) tools like Apache Nifi or Talend.

The following paragraphs provide various examples of the embodiments disclosed herein.

### Clause 1

A system for generating unified logbook data, the system comprising: at least one electronic processor, the at least one electronic processor configured to: receive, from a user device, a request to register the user device with a logbook processing service based on a registration credential; in response to registering the user device, receive a user login credential from the user device; in response to verifying the user login credential, receive an image of logbook data from the user device, wherein logbook data includes data collected using one or more scientific instruments; in response to receiving the image of logbook data, record a unique identifier of the user device along with an indication of the logbook data included in the image of logbook data; extract textual logbook data from the image using natural language processing; and organize the extracted textual logbook data into a structured format, using a model, to generate unified logbook data.

### Clause 2

The system of clause 1, wherein the at least one electronic processor is further configured to: generate a notification regarding the logbook data based at least in part on the extracted textual logbook data, wherein the notification identifies an organization suggestion for the extracted textual logbook data, an anomaly in the extracted textual logbook data, or a potential error associated with the extracted textual logbook data; and record the notification and an action taken based on the notification.

### Clause 3

The system of clause 2, wherein the at least one electronic processor is further configured to: send to a user device at least one selected from the group consisting of the unified logbook data and the notification.

### Clause 4

The system of clause 2, wherein the model is one selected from the group consisting of a machine learning model and a rules-based model.

### Clause 5

The system of clause 4, wherein the at least one electronic processor is further configured to: receive feedback, wherein the feedback includes whether an action was taken based on the notification and a type of action taken based on the notification; and retrain the model based on the feedback, wherein the model is a machine learning model.

### Clause 6

The system of clause 2, wherein the potential error associated with the logbook data is at least one selected from the group consisting of a sample error, a grammatical error, and a spelling error.

### Clause 7

The system of clause 1, wherein the at least one electronic processor is configured to generate unified logbook data by performing at least one selected from the group consisting of categorizing logbook entries in the extracted textual logbook data, organizing logbook entries included in the extracted textual logbook data, tagging logbook entries with relevant labels, grouping logbook entries in the extracted textual logbook data, and identifying and extracting key information from logbook entries in the extracted textual logbook data.

### Clause 8

The system of clause 2, wherein the anomaly in the logbook data is at least one selected from the group consisting of experimental results that deviate from historical data or established norms by a predetermined threshold, outliers in sample characteristics, unusual patterns in timing or frequency of experimental procedures or sample preparation steps, aberrations in recorded measurements or observations, and sudden changes in behavior of samples.

### Clause 9

The system according to clause 6, wherein the sample error is at least one selected from the group consisting of a potential contamination issue, an equipment failure or malfunction, a sample degradation risk, a quality issue, and a delay or issue in an experimental process used.

### Clause 10

The system according to clause 1, wherein the at least one electronic processor is further configured to: generate a notification identifying a required field in a logbook entry included in the logbook data, wherein the required field is blank or filled with an incorrect data type; and send, to a user device, the notification identifying the required field.

### Clause 11

A method for generating unified logbook data, the method comprising: receiving, from a user device, a request to register the user device with a logbook processing service based on a registration credential; in response to registering the user device, receiving a user login credential from the user device; in response to verifying the user login credential, receiving an image of logbook data from the user device, wherein logbook data includes data collected using one or more scientific instruments; in response to receiving the image of logbook data, recording a unique identifier of the user device along with an indication of the logbook data included in the image of logbook data; extracting textual logbook data from the image using natural language processing; and organizing the extracted textual logbook data into a structured format, using a model, to generate unified logbook data.

### Clause 12

The method of clause 11, the method further comprising: generating a notification regarding the logbook data based at least in part on the extracted textual logbook data, wherein the notification identifies an organization suggestion for the extracted textual logbook data, an anomaly in the extracted textual logbook data, or a potential error associated with the extracted textual logbook data; and recording the notification and an action taken based on the notification.

### Clause 13

The method of clause 12, the method further comprising: sending to a user device at least one selected from the group consisting of the unified logbook data and the notification.

### Clause 14

The method of clause 12, wherein the model is one selected from the group consisting of a machine learning model and a rules-based model.

### Clause 15

The method of clause 14, the method further comprising: receiving feedback, wherein the feedback includes whether an action was taken based on the notification and a type of action taken based on the notification; and retraining the model based on the feedback, wherein the model is a machine learning model.

### Clause 16

The method of clause 12, wherein the potential error associated with the logbook data is at least one selected from the group consisting of a sample error, a grammatical error, and a spelling error.

### Clause 17

The method of clause 11, wherein the at least one electronic processor is configured to generate unified logbook data by performing at least one selected from the group consisting of categorizing logbook entries in the extracted textual logbook data, organizing logbook entries included in the extracted textual logbook data, tagging logbook entries with relevant labels, grouping logbook entries in the extracted textual logbook data, and identifying and extracting key information from logbook entries in the extracted textual logbook data.

### Clause 18

The method of clause 12, wherein the anomaly in the logbook data is at least one selected from the group consisting of experimental results that deviate from historical data or established norms by a predetermined threshold, outliers in sample characteristics, unusual patterns in timing or frequency of experimental procedures or sample preparation steps, aberrations in recorded measurements or observations, and sudden changes in behavior of samples.

### Clause 19

The method according to clause 16, wherein the sample error is at least one selected from the group consisting of a potential contamination issue, an equipment failure or malfunction, a sample degradation risk, a quality issue, and a delay or issue in an experimental process used.

### Clause 20

The method according to clause 10, the method further comprising: generating a notification identifying a required field in a logbook entry included in the logbook data, wherein the required field is blank or filled with an incorrect data type; and sending, to a user device, the notification identifying the required field.

What is claimed is:

1. A system for generating unified logbook data, the system comprising:
at least one electronic processor, the at least one electronic processor configured to:
receive, from a user device, a request to register the user device with a logbook processing service based on a registration credential;
in response to registering the user device, receive a user login credential from the user device;
in response to verifying the user login credential, receive an image of logbook data from the user device, wherein logbook data includes data collected using one or more scientific instruments;
in response to receiving the image of logbook data,
record a unique identifier of the user device along with an indication of the logbook data included in the image of logbook data;
extract textual logbook data from the image using natural language processing; and
organize the extracted textual logbook data into a structured format, using a model, to generate unified logbook data.

2. The system of claim 1, wherein the at least one electronic processor is further configured to:
generate a notification regarding the logbook data based at least in part on the extracted textual logbook data, wherein the notification identifies an organization suggestion for the extracted textual logbook data, an anomaly in the extracted textual logbook data, or a potential error associated with the extracted textual logbook data; and
record the notification and an action taken based on the notification.

3. The system of claim 2, wherein the at least one electronic processor is further configured to:
send to a user device at least one selected from the group consisting of the unified logbook data and the notification.

4. The system of claim 2, wherein the model is one selected from the group consisting of a machine learning model and a rules-based model.

5. The system of claim 4, wherein the at least one electronic processor is further configured to:
receive feedback, wherein the feedback includes whether an action was taken based on the notification and a type of action taken based on the notification; and
retrain the model based on the feedback, wherein the model is a machine learning model.

6. The system of claim 2, wherein the potential error associated with the logbook data is at least one selected from the group consisting of a sample error, a grammatical error, and a spelling error.

7. The system of claim 1, wherein the at least one electronic processor is configured to generate unified logbook data by performing at least one selected from the group consisting of categorizing logbook entries in the extracted textual logbook data, organizing logbook entries included in the extracted textual logbook data, tagging logbook entries with relevant labels, grouping logbook entries in the extracted textual logbook data, and identifying and extracting key information from logbook entries in the extracted textual logbook data.

8. The system of claim 2, wherein the anomaly in the logbook data is at least one selected from the group consisting of experimental results that deviate from historical data or established norms by a predetermined threshold, outliers in sample characteristics, unusual patterns in timing or frequency of experimental procedures or sample preparation steps, aberrations in recorded measurements or observations, and sudden changes in behavior of samples.

9. The system according to claim 6, wherein the sample error is at least one selected from the group consisting of a potential contamination issue, an equipment failure or malfunction, a sample degradation risk, a quality issue, and a delay or issue in an experimental process used.

10. The system according to claim 1, wherein the at least one electronic processor is further configured to:
generate a notification identifying a required field in a logbook entry included in the logbook data, wherein the required field is blank or filled with an incorrect data type; and
send, to a user device, the notification identifying the required field.

11. A method for generating unified logbook data, the method comprising:
receiving, from a user device, a request to register the user device with a logbook processing service based on a registration credential;
in response to registering the user device, receiving a user login credential from the user device;
in response to verifying the user login credential, receiving an image of logbook data from the user device, wherein logbook data includes data collected using one or more scientific instruments;
in response to receiving the image of logbook data,
recording a unique identifier of the user device along with an indication of the logbook data included in the image of logbook data;
extracting textual logbook data from the image using natural language processing; and
organizing the extracted textual logbook data into a structured format, using a model, to generate unified logbook data.

12. The method of claim 11, the method further comprising:
generating a notification regarding the logbook data based at least in part on the extracted textual logbook data, wherein the notification identifies an organization suggestion for the extracted textual logbook data, an anomaly in the extracted textual logbook data, or a potential error associated with the extracted textual logbook data; and
recording the notification and an action taken based on the notification.

13. The method of claim 12, the method further comprising:
sending to a user device at least one selected from the group consisting of the unified logbook data and the notification.

14. The method of claim 12, wherein the model is one selected from the group consisting of a machine learning model and a rules-based model.

15. The method of claim 14, the method further comprising:
receiving feedback, wherein the feedback includes whether an action was taken based on the notification and a type of action taken based on the notification; and
retraining the model based on the feedback, wherein the model is a machine learning model.

16. The method of claim 12, wherein the potential error associated with the logbook data is at least one selected from the group consisting of a sample error, a grammatical error, and a spelling error.

17. The method of claim 11, wherein the at least one electronic processor is configured to generate unified logbook data by performing at least one selected from the group consisting of categorizing logbook entries in the extracted textual logbook data, organizing logbook entries included in the extracted textual logbook data, tagging logbook entries with relevant labels, grouping logbook entries in the extracted textual logbook data, and identifying and extracting key information from logbook entries in the extracted textual logbook data.

18. The method of claim 12, wherein the anomaly in the logbook data is at least one selected from the group consisting of experimental results that deviate from historical data or established norms by a predetermined threshold, outliers in sample characteristics, unusual patterns in timing or frequency of experimental procedures or sample preparation steps, aberrations in recorded measurements or observations, and sudden changes in behavior of samples.

19. The method according to claim 16, wherein the sample error is at least one selected from the group consisting of a potential contamination issue, an equipment failure or malfunction, a sample degradation risk, a quality issue, and a delay or issue in an experimental process used.

20. The method according to claim 10, the method further comprising:
generating a notification identifying a required field in a logbook entry included in the logbook data, wherein the required field is blank or filled with an incorrect data type; and
sending, to a user device, the notification identifying the required field.
